(19) United States
(12) Patent Application Publication
(10) Pub. No.: US 2024/0378028 A1
(43) Pub. Date: Nov. 14, 2024

(54) AUTOMATED AUTHORING OF SOFTWARE SOLUTIONS FROM A DATA MODEL

(71) Applicant: 27 Software U.S. Inc. dba DXterity Solutions, Mooresville, NC (US)

(72) Inventor: Christopher Zee Chartrand, Brantford (CA)

(21) Appl. No.: 18/286,575

(22) PCT Filed: Apr. 15, 2022
(86) PCT No.: PCT/US2022/024937

§ 371 Date: Oct. 12, 2023

(51) Int. Cl. G06F 8/35; G06F 8/36; G06F 8/38

(52) U.S. Cl. CPC G06F 8/35; G06F 8/36; G06F 8/38

(57) ABSTRACT

Automatically generating code and related artifacts from an abstract model of a legacy database, an entity relationship diagram, or other schema. The model may be analyzed to detect normalization, rationalization, naming conventions, structure conventions, and other anomalies and may be used to suggest scripted solutions for resolving the discovered anomalies. The generated code may be exposed and further extendable. The generated code may exhibit context patterns, action patterns, user interface patterns and/or other features

### CROSS REFERENCE TO RELATED APPLICATIONS

This application claims priority to three co-pending U.S. patent application Ser. No. 17/232,444 filed Apr. 16, 2021 entitled “Automated Authoring of Software Solutions by First Analyzing and Resolving Anomalies in a Data Model” and Ser. No. 17/232,487 filed Apr. 16, 2021 “Automated Authoring of Software Solutions From a Data Model with Related Patterns”, and Ser. No. 17/232,520 filed Apr. 16, 2021 “Automated Authoring of Software Solutions From a Data Model”, each of which are hereby incorporated by reference.

### BACKGROUND

The world is undergoing a digital transformation; using data to become faster, cheaper, smarter and more convenient to customers. Companies, schools, churches, and governments around the world are collectively investing trillions of US dollars each year in technology to become more competitive and more profitable.

High quality software applications are core to a successful digital transformation. Here are some types of software projects that are part of nearly every such process:
New software applications and prototyping: Quickly-built prototypes of software programs initially prove that new business models can work. The prototypes are typically then re-written into much larger and scalable enterprise software applications. New software applications that are often used to disrupt older business models and large applications can take 18-24 months to construct using teams of developers.
Legacy software programs: Millions of decades-old programs are expensive to maintain and the programmers who built the programs have either died or retired, making it risky to touch, change, or upgrade those legacy software applications without experienced staff on hand. Old programs within a company's production environment create security vulnerabilities, are challenging to move to the cloud environment, and are prone to break, threatening a company's ongoing operations every day. The legacy applications must be replaced.
Integration: Software programs need to talk to other software programs more than ever before. To communicate and share data they use software apps, APIs (application programming interfaces), which are complex and specialized, requiring significant time to build.

Unfortunately, there are impediments and bottlenecks to digital transformation efforts. These barriers reduce productivity and reduce the quality of the software applications/programs that are produced. Some of the more important ones are:
Shortage of software developers: There is an estimated shortage of 1 million experienced programmers in North America. Companies are held hostage by lack of talent; productivity suffers, long delays to complete projects, growing backlogs of projects obstruct competitiveness and profitability.
Software development process: The process to develop software has not changed in decades. At the core, software programs are built through writing code “by hand”. By its nature, this process is inefficient and lacks excellent tools and lacks adherence to common standards, run by individual developers who act more as “artists” who code in their own style.

Object-relational mapping (ORM) is a programming technique for converting data between incompatible type systems using object-oriented programming languages. ORM creates, in effect, a “virtual object database” that can be used from within the programming language.

In one application of ORM, many popular database products such as SQL database management systems (DBMS) are not object-oriented and can only store and manipulate scalar values such as integers and strings organized within tables. ORM tools can be used to translate the logical representation of the objects into an atomized form that is capable of being stored in a relational database while preserving the properties of the objects and their relationships so that they can be reloaded as objects when needed.

US Patent Publication 2010/082646 is one example of Object Relational Mapping (ORM) where a dependency graph generator receives a combination of object level custom commands and store level dynamic commands. Each store level dynamic command is generated from at least one object level dynamic command. The dependency graph generator is configured to generate a dependency graph that includes nodes and at least one edge coupled between a corresponding pair of nodes. Each node is associated with a corresponding store level dynamic command or an object level custom command. An edge is configured according to an identifier associated with the corresponding pair of nodes and a dependency between commands associated with the corresponding pair of nodes.

US Patent Publication 2006/179025 describes a system for managing a knowledge model defining a plurality of entities. The system includes an extraction tool for extracting data items from disparate data sources that determines if the data item has been previously integrated into the knowledge model. The system also includes an integration tool for integrating the data item into the knowledge model only if the data item has not been previously integrated into the knowledge model. Additionally, a relationship tool for identifying, automatically, a plurality of relationships between the plurality of entities may also be provided. The system may also include a data visualization tool for presenting the plurality of entities and the plurality of relationships.

US Patent Publication 2013/145348 describes a software application platform that abstracts a computing platform, a database layer, and a rendering medium. A platform-independent application programming interface is disclosed, as well as an abstract database layer. The abstraction of the database layer comprises two sub-layers, including a layer having a uniform interface that treats data records as plain objects and a layer having constructs that facilitate the automated generation of user interfaces for data record navigation and management. Further, a software application platform that is independent of rendering medium is disclosed.

U.S. Patent Publication 2011/0088011 provides a system and method for automatically generating enterprise software applications with minimal level of manual coding. A graphical design tool models an application using a Unified Model Language (UML), validates the UML model, and automatically generates a deployable application. A framework of libraries can supply a base from which the target application can be built.

International Patent Publication WO2021/011691 describes how database entries and tools for accessing and searching the database are generated from an Ontology. Starting with an ontology used to represent data and relationships between data, the system and methods described enable that data to be stored in a desired type of database and accessed using an API and via a search query generated from the Ontology. Embodiments provide a structure and process to implement a data access system or framework that can be used to unify and better understand information across an organization's entire set of data. Such a framework can help enable and improve the organization and discovery of knowledge, increase the value of existing data, and reduce complexity when developing next-generation applications.

US Patent Publication 2012/179987 provides a computationally efficient system and method for developing extensible and configurable Graphical User Interfaces (GUIs) for database-centric business application product lines using model driven techniques and also reduces the cost as well as time for creating new GUIs for the same which enables effective maintenance and smooth evolution using model driven technique. Modeling of commonality and variability of GUIs leads to a single GUI for the database-centric business application product lines. A model-based solution addresses extensibility and configurability of both structural and behavioral aspects in the GUI and it also supports realize variations at runtime in the presentation layer by using variable fields which can check the configuration data from a configuration database and decide whether to render itself or not.

US Patent Publication 2006/0179025 describes a system for managing a knowledge model defining a plurality of entities. The system includes an extraction tool for extracting data items from disparate data sources that determines if the data item has been previously integrated into the knowledge model. The system also includes an integration tool for integrating the data item into the knowledge model that integrates the data item into the knowledge model only if the data item has not been previously integrated into the knowledge model. Additionally, a relationship tool for identifying, automatically, a plurality of relationships between the plurality of entities may also be provided. The system may also include a data visualization tool for presenting the plurality of entities and the plurality of relationships.

US Patent Publication 2013/145348 is a software application platform that abstracts a computing platform, a database layer, and a rendering medium. A platform-independent application programming interface is disclosed, as well as an abstract database layer. The abstraction of the database layer comprises two sub-layers, including a layer having a uniform interface that treats data records as plain objects and a layer having constructs that facilitate the automated generation of user interfaces for data record navigation and management. Further, a software application platform that is independent of rendering medium is disclosed.

US Patent Publication 2010/082646 describes techniques for object relational mapping (ORM). A dependency graph generator receives a combination of object level custom commands and store level dynamic commands. Each store level dynamic command is generated from at least one object level dynamic command. An identifier is assigned to each entity present in the object level custom commands and the object level dynamic commands. A store level dynamic command includes any identifiers assigned in the corresponding object level dynamic command(s). The dependency graph generator is configured to generate a dependency graph that includes nodes and at least one edge coupled between a corresponding pair of nodes. Each node is associated with a corresponding store level dynamic command or an object level custom command. An edge is configured according to an identifier associated with the corresponding pair of nodes and a dependency between commands associated with the corresponding pair of nodes.

### SUMMARY OF PREFERRED EMBODIMENTS

This patent relates to techniques for automatic code generation from a model. The model is generated from an input data source. In one example, the data source may be a legacy database. However, prior to generating code, the data model is analyzed to detect anomalies such as normalization and rationalization form issues. The system then attempts (with limited to no developer input) to script contextualized solutions that resolve or at least improve the issues discovered. In addition, the detected issues are used to determine a quality score for the model. The quality score may be weighted by issue type. Code generation is not permitted to continue until the quality score exceeds a threshold.

Among the benefits of this approach is that a better data schema results, providing cascading positive effects in both maintenance, speed and coding efficiencies.

More particularly, the approach may then read the data and metadata of the model, automatically generating an application that contains thousands or millions of lines of code, to produce a full enterprise software application. The generated stack may contain many components, including data access layer, logic tiers, web Application Programming Interface (API), web User Interface (UI), unit tests, and documentation. Any time a change is made to the database model, which may happen often, the application may be regenerated to stay in synch with the change in the database; easily again completed in a few minutes, saving weeks or months of programmer work. Indeed, because the entire stack is automatically produced in a few minutes, the software application even may be regenerated many times a day, if needed. Applications are thus always new, fresh, and never become old, legacy applications.

In one example use case, an organization may use this approach to migrate an application from a legacy, on-premises technology platform to a cloud native, API based technology stack.

In that use case, the system consumes a physical database model from the legacy application or if a physical database model is not available, then builds a new abstract model as a starting point. The system then analyzes and scores this model, recommending and implementing resolutions that will improve the quality of code generation. The analysis may compare that model against metrics such as normalization, rationalization, form conventions and the like. Once the score passes a threshold, the physical database model is used to generate an abstract model. The abstract model in turn, including any resulting data and metadata, are used to generate a full enterprise class code framework. The framework may include database code (such as MySQL, SQL, Oracle or PostgreSQL in some examples), as well as other artifacts such as. Net, .Net Core or Java components.

Core source code (including many business rules generated directly from the data model), libraries, web API, web UI, unit testing, documentation, solution files and abstracted model are generated. The output may be containerized using dockers and deployed on a cloud platform. Changes may be made to the physical database model or to the abstract model (and scripted to the DB) and new code generated incorporating the changes made to the DB without losing extended, customized code, such as special business rules or enhanced UI. Generated granular entity level micro API's (REST, OData, and GraphQL) work as a microservices layer to operate on the data. These micro data centric APIs in conjunction with developer defined business or functional rules may be exposed for any front end (UI/UX) to facilitate end user interface.

This patent also relates to techniques for automatically generating code and related artifacts such as application programming interfaces (APIs) and related documentation from an abstract model. The abstract model is generated from a source such as a legacy database, an entity relationship diagram, or other schema defining the data tables, objects, entities, or relationships etc. in the source.

The approach may be used to generate code representing an enterprise grade solution from the model. The code may be exposed (that is, made visible to the developer) in its pre-compiled state. The generated code is therefore configurable and extendable via a user interface. Any such extended code is maintained in a structure (such as a file or folder) separately from where the generated code is stored. The extended code structure serves as a location for later placement of developer code.

In one particular aspect, an API and related documentation are also generated from the abstract model. This may include a fully hydrated, standardized API (such as a GraphQL or Rest or OData compliant API).

There are many advantages to this approach. It generates a complete application including code, an API, and related UI documentation, in a form that is automatically structured in the same way that a competent senior developer would structure. As a result, developer effort and time are greatly reduced, with a vast improvement in quality control and standardization of the resulting code. These improvements reduce long term maintenance costs. Because the abstract model is exposed to the developer, the application may be continuously modified, while it is deployed to the end user, and such modifications will automatically propagate to the generated code.

In one particular use case, the system consumes a physical model of a data source, such as a database for a legacy application. An abstract model is generated from the physical model. The system then analyzes the abstract model and generates resulting executable code and metadata that corresponds to the abstract model. The legacy database application may take any form (such as MySQL, SQL Server, DB2, Oracle, Access, Teradata, Azure, PostgreSQL, etc.), and the generated code result may be any of several selectable enterprise class frameworks (such as .Net, .Net Core or Java, etc.). Other use cases are possible.

The generated code may include core code (such as code that implements business rules common to typical enterprise class solutions). The core code (together with other external libraries) may provide a foundation upon which the developer's application-specific logic is generated. The generated solution therefore may contain core code and external libraries as well as the solution-specific components such as application logic, web API, web UI, documentation, unit tests, and the like.

The output may be instantiated on premises, containerized using dockers, or deployed on a cloud platform, to expose the solution logic. This then enables the developer to manually extend or customize the logic with specialized business rules or enhancements to a related UI or API. Any such extended code logic (or UI or API) is maintained separately from automatically generated code.

Also, by placing and maintaining extended code in a file, folder, framework or other structure that is separated from where the generated code is stored, any changes made to the abstract model which is then used for regeneration of the code will not overwrite or otherwise affect or lose any of the extended, customized code.

Generated granular entity level micro-API's (such REST, OData, or GraphQL) may work as a microservices layer to operate on the data. These micro data centric APIs in conjunction with developer defined business or functional rules may be exposed for any front end (UI/UX) to further facilitate customizing the end user interface.

This patent furthermore relates to techniques for automatically generating code and related artifacts such as application programming interfaces (APIs) and related documentation from an abstract model. The abstract model is generated from a source such as a legacy database, an entity relationship diagram, or other schema defining the data tables, objects, entities, or relationships etc. in the source. The generated code exhibits several patterns, interfaces and/or features.

Separation of code that is automatically generated and code that is typically written by a software developer. Through use of software patterns and interfaces, generated code is distinct and self-contained versus developer-generated extended code (both physically and conceptually). Custom code is never lost allowing for instantaneous code regeneration. As a result, developers may stay focused on what is important without being distracted by all the “base” code.

Context patterns. Code for selected contexts is retained as distinct, replaceable and upgradable blocks without modifying any underlying code structures (classes). These may include Localization, Messaging, Logging, Exception management, Auditing, Validation, Cryptography, Email, and Cache management classes.

Response and action patterns. A common ability (via a rich object) for methods to serialize and communicate within and between application tiers. This massively simplifies and stabilizes generated code, making it easier to integrate User Interface (UI) feedback as a response pattern persists through application tiers.

Code generator (Author) patterns. Both data sources and programming languages are abstracted by the code generation technology, allowing for the ability to extend into other technologies existing or in the future. This may include code generation patterns for language interfaces, output interfaces, database interfaces, common replacement utilities, method factories, class factories, operating systems and the like. The level of meta-programming has many auxiliary benefits such as the ability to generate valuable documentation and even code metrics.

User Interface (UI) patterns. A rich user interface is built from the model. The generated UI may be extended via the functionality within the UI in order to customize the final user interface experience for enterprise applications. The generated solution is different since it is driven solely by meta data provided from the model and configuration data-making maintenance of the solution significantly easier.

More particularly, a model is used to generate base application code and an extended application code structure. The extended application code structure is used for subsequent placement of extended application code. Components of the extended application code may include one or more code extensions, attributes, properties or rules for the database that are specified other than by generating from the model. Patterns are further provided that define aspects of the generated code.

The extended application code structure may be stored separately from the base application code.

The base application code and extended application code structure may then be exposed for review such as a by a developer. Developer modifications, if any, to the base application code are then accepted.

The patterns may comprise context patterns that define handler classes for one or more contextual elements for the generated code. These contextual elements may be global to the application. In still other aspects, the contextual elements may be Localization, Messaging, Logging, Exception management, Auditing, Validation, Cryptography, Communications, or Cache management elements.

In other aspects, the patterns may include action-response patterns that define responses generated when corresponding actions are taken. The action-response patterns may define serialization of responses among code tiers or between code tiers. In some implementations, the code tiers may include application logic code, API code and UI code. In other aspects, the action-response patterns may include append methods that define how to respond to successive responses from other tiers.

The base code and extended application code structure may be further organized such as by language and then by project.

The base code may also include constructors, declarations, methods and properties classes, or code generation-related tasks.

A schema may be used to define attributes of a user interface associated with classes. As such, a user interface may then be generated by consuming the schema at a time a web page view is requested by a user.

### BRIEF DESCRIPTION OF THE DRAWINGS

Additional novel features and advantages of the approaches discussed herein are evident from the text that follows and the accompanying drawings, where:

FIG. 1 is a high-level diagram of the features of an example system for automatic code generation.

FIG. 2 is more detailed view of one use case.

FIG. 3 lists some of the high-level steps in one preferred process.

FIGS. 4A and 4B are a logical flow of the abstract model generation, analysis and resolution.

FIG. 5 is a hierarchy of some example rating metrics and resolution suggestions for detected anomalies.

FIG. 6 is an example of a weighted quality score.

FIG. 7 is a block diagram of analysis and resolution functions.

FIG. 8 is an example user interface screen illustrating detected warnings.

FIG. 9 is an example user interface screen illustrating a proposed resolution.

FIG. 10 is another example of how resolutions may be reported to the developer.

FIGS. 11 through 13 are an example interface for selecting configuration options for the analyzer.

FIG. 14 is a diagram illustrating a hierarchy of functions performed on an abstract model to generate code as an extensible enterprise-class framework, Application Programming Interface (API), User Interface (UI) and related documentation.

FIG. 15A is a conceptual diagram illustrating how the resulting code is arranged in a hierarchy of files including core, base and extended logic, base and extended APIs, and base and extended UIs.

FIG. 15B is an example flow for how regeneration may affect base code differently from extended code.

FIG. 16 is an example physical model as may represent a source database.

FIG. 17 is a high-level view of the resulting abstract model generated from the physical model.

FIG. 18 is an example of how a developer may set attributes, properties, or rules within the platform.

FIG. 19 is an example of setting details for a particular entity.

FIG. 20 is an example of how rules may be enforced in the abstract model.

FIG. 21 shows how a developer may modify an entity data type in the abstract model.

FIG. 22 is an example hierarchy of the generated code, API, and documentation.

FIGS. 23A, 23B and 23C are a more detailed example code that implements a “project” entity.

FIG. 24 is an example of enumerated values implemented in the code.

FIG. 25 shows a generated UI where the data entered for an email address entity does not comply with a required format.

FIG. 26 is an example of using the platform, after generating code, to modify an attribute of an entity.

FIG. 27 illustrates how a property of an entity may be extended by a developer.

FIG. 28 shows extended code stored separately from the automatically generated code.

FIG. 29 is an example Rest API generated from the abstract model.

FIG. 30 is an example of a fully documented GraphQL API.

FIG. 31 is a more detailed view of the fully documented GraphQL API for a “clientID” entity.

FIG. 32 illustrates how the code may be architected for a GraphQL API.

FIG. 33 illustrates an example GraphQL API and its generated documentation.

FIG. 34 is similar to FIG. 33 and shows another documentation example.

FIG. 35 is an example OData API.

FIG. 36 is an example of full hydration.

FIG. 37 lists some of the advantages of the approach described herein.

FIG. 38 illustrates other advantages.

FIG. 39 is a conceptual diagram illustrating how the resulting code is arranged in a hierarchy of code blocks including core, base and extended logic, base and extended APIs, and base and extended UIs.

FIG. 40 is an example class diagram illustrating resulting patterns of generated code.

FIG. 41 is an example of code generated for a database application intended to support a university.

FIG. 42 shows how a developer may review the patterns of generated code including separate structures for base code and extended code.

FIG. 43 is a similar example showing separately stored code for an API.

FIG. 44 is an example pattern for public context code.

FIG. 45 is an example pattern for private context code.

FIG. 46 is an example action-response pattern for a constructor.

FIG. 47 shows example valid and negative response patterns.

FIG. 48 is an example pattern for specifying response message filters and formats.

FIG. 49 is an illustration of what the code author does.

FIG. 50 is an example .Net framework for generated classes.

FIG. 51 shows the organization of an example resource file.

FIG. 52 shows an example .Net framework for code generation tasks.

FIG. 53 is an example user interface for the author.

FIG. 54 is an example of where UI schema are stored.

FIG. 55 is an example list schema.

FIG. 56 is an example of a detailed schema.

FIG. 57 is an example UI for defining a schema.

FIG. 58 shows how a developer may specify UI attributes for a class.

FIG. 59 shows how a developer may specify custom actions

FIG. 60 is an example end user Web interface.

### DETAILED DESCRIPTION OF ILLUSTRATIVE EMBODIMENT(S)

### I. Automated Authoring of Software Solutions by First Analyzing and Resolving Anomalies in a Data Model

### System Overview

As explained above, the present invention relates to a system and methods that may consume a data source and transform it into an abstract model. The abstract model may then be extended and then used to automatically generate base code, Application Programming Interfaces (APIs), User Interfaces (UI), documentation, and other elements. Each of the generated base code, generated base APIs and generated base UIs may be extended. Extended elements are maintained in a framework, such as a different source code file, separately from generated based code elements. More details for one example method of generating code are provided in the co-pending patent applications already incorporated by reference above. The abstract model acts as an intermediary between data models and/or conceptual entity relationship diagrams and code.

Of specific interest herein is that before generating code, the model is first analyzed to detect normalization, rationalization, naming conventions, structure conventions, and other anomalies. The analysis is scored, and the score may be weighted according to selected metrics. The analysis also suggests scripted solutions for resolving the discovered anomalies. For example, scripts to add missing foreign key references, to add foreign key tables, to add primary keys, to normalize column data types, to normalize column names, so forth may be suggested. The developer may then choose to implement one or more of the suggested solutions prior to code generation.

The score may be compared to a threshold and the result used to gate subsequent actions. For example, generation of code from the abstract model may be prevented until such time as the score meets at least a minimum threshold score.

Artificial intelligence techniques, such as a machine learning engine, may also use the quality metric to aid the selection and/or creation of one or more scripted resolutions. For example, the machine learning engine may automatically try number of different scripted solutions until the quality metric is optimized.

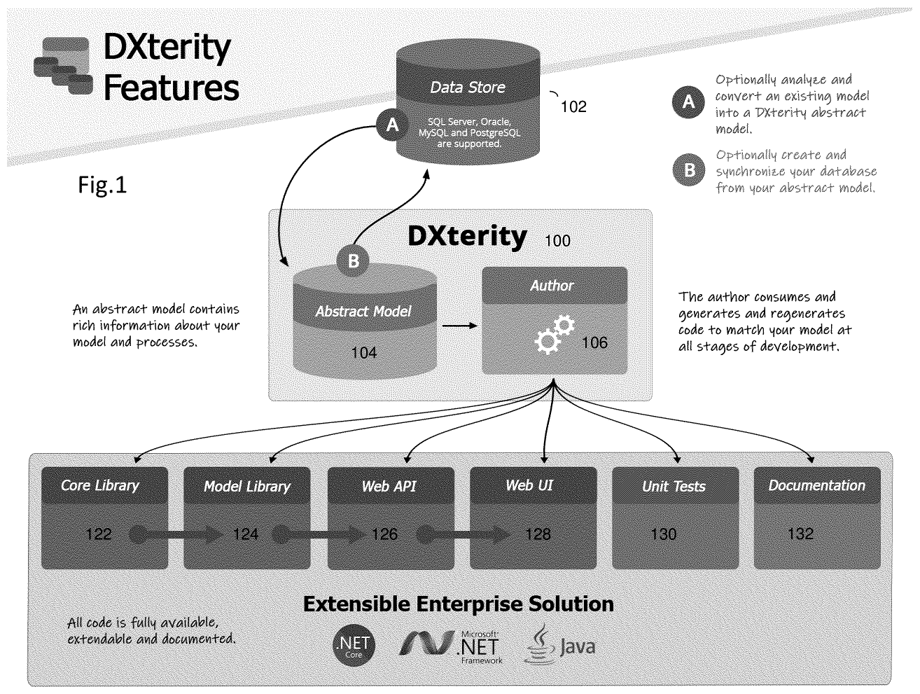

An example implementation will now be described and shown, starting with FIG. 1. Here a data source, such as data store 102, is made available to a productivity platform 100 referred to herein as DXterity. The data store 102 may, for example, be a database associated with a legacy software application. However, it should be understood that the source may not necessarily be a legacy application but some newer application. The data store may be in any common form such as MySQL, SQL Server, DB2, Oracle, Access, Teradata, Azure, PostgreSQL or the like.

DXterity 100 is then used to generate an abstract model 104 from the input data store 102. The abstract model 104 is then fed to an author 106. The author 106 automatically consumes the model 104 to generate and regenerate code to match the model 104. The author may generate the code in certain forms, and also generate other artifacts related to the model 104. For example, the author 106 may generate or may use a core code library 122 and/or model library 124. But the author may also generate application base logic, a web application interface 126, a user interface 128, unit tests 130, and/or documentation 132 from the abstract model.

The input source may describe the data in a database in other ways, such as via an entity relationship diagram, as explained in more detail below. The abstract model is generated in a particular way to help ensure that the resulting code 122, 124 conforms to expected criteria. For example, DXterity 100 may be configured to ensure that the resulting generated code and artifacts 122-132 provide an extensible, enterprise-class software solution. As will be understood from the discussion below, this is accomplished by ensuring that the model itself conforms to certain metrics or conventions prior to code generation.

Enterprise class software is computer software used to satisfy the needs of an organization rather than individual users. Enterprise software forms integral part of a computer-based information system that serves an organization; a collection of such software is called an enterprise system. These enterprise systems handle a chunk of data processing operations in an organization with the aim of enhancing the business and management reporting tasks. The systems must typically process information at a relatively high speed and can be deployed across a variety of networks to many users. Enterprise class software typically has, implements or observes many of the following functions or attributes: security, efficiency, scalability, extendability, collaboration, avoidance of anti-patterns, utilization of software patterns, architected, designed, observes naming and coding and other standards, provides planning and documentation, unit testing, serialized internal communication, tiered infrastructure, exception management, source code and version control, and includes interfaces for validation, messaging, communication, cryptography, localization, logging and auditing.

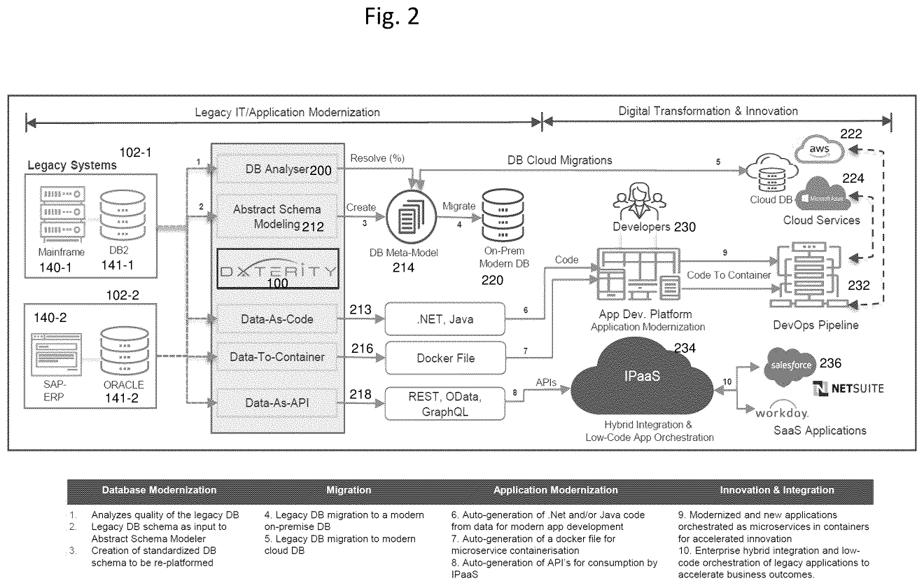

FIG. 2 illustrates an example implementation in a bit more detail than FIG. 1. Here there are two input data stores, respectively associated with two legacy systems 102-1, 102-2 including an IBM mainframe 140-1 running a DB2 instance 141-1 and an SAP/ERP application 140-2 accessing an Oracle database 141-2.

The DXterity platform 100 consists of an analyzer component 200 and a schema modelling component 212. The schema modelling component 212 generates abstract models of the legacy databases 141-1, 141-2.

The analyzer component 200 analyzes the abstract models of the legacy databases 141-1, 142-2 against selected metrics, generates a score, and recommends resolutions to improve the scores.

A standardized database schema is then output from DXterity 100 as a meta model 214. The meta model 214 may then be re-platformed in various ways. For example, it may be migrated to an on-premise modern database 220. Or the meta model may be migrated to a cloud provider 222 or as a cloud service 224.

Artifacts generated by the DXterity platform 100 may also be fed to other related functions, including an application development platform 230 that drives DevOps pipelines 232, or integration/orchestration environments 234 that support specific application development platforms 236.

Also, of interest is that the DXterity platform 100 may be used to generate its result as data-as-code 213 (e.g., as .NET, or Java), data-to-container 216 (e.g., as a Docker file), or data-as-API 218 (e.g., as REST, OData, GraphQL, etc.).

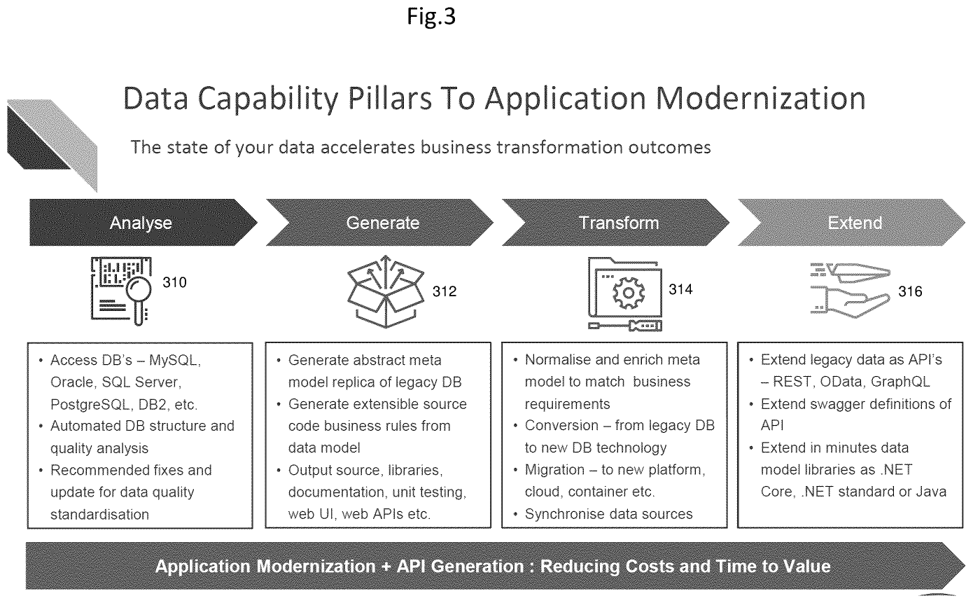

FIG. 3 is a more particular list of the functions that may be performed by DXterity 100 towards generating an extensible enterprise class solution, including analysis 310, model generation 312, transformation 314 and extension 316.

The analysis function 310 automatically analyzes the structure of the input data store(s) or models thereof, generates a quality score, and recommends fixes or updates for any anomalies that are negatively impacting the quality score.

The generating function 312 generates the abstract meta-model mentioned previously. Code generated from this meta-model may be extensible, enterprise class source code conforming to the metrics enforced in the analysis function 310. The result may include not only source code and libraries, but also related documentation, user interfaces, APIs and the like.

The transformation function 314 may normalize or enrich the model to match particular business requirements. This may, for example, convert data from a legacy database format to a new database technology, or migrate the data to new platforms, the cloud, or containers, or synchronize different data sources. In other implementations, new data from an input source in one format may be converted to another format.

Extension functions 316 may extend data as APIs (through a REST, OData, GraphQL), or extend swagger definitions or .NET Core, .NET standard, or Java as required.

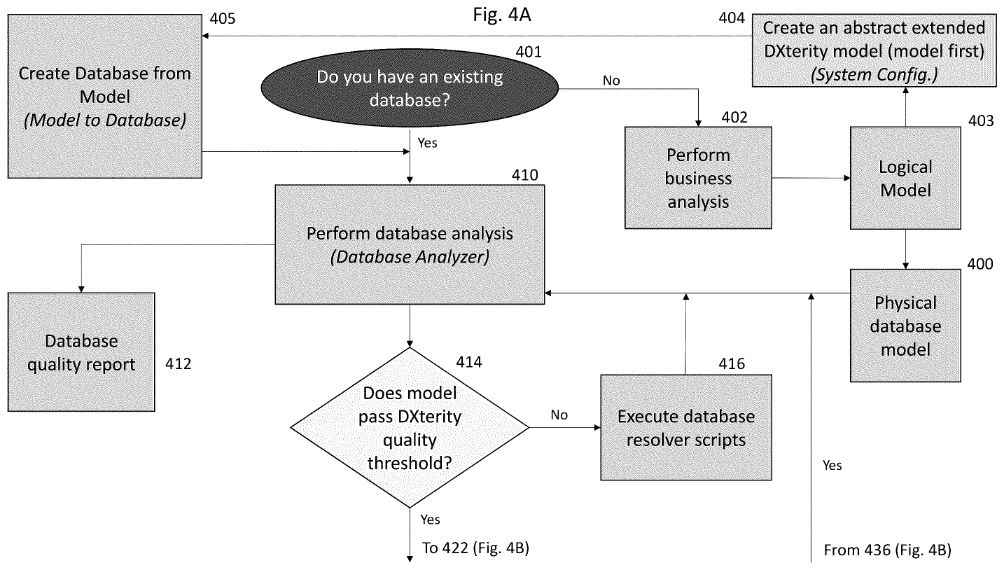

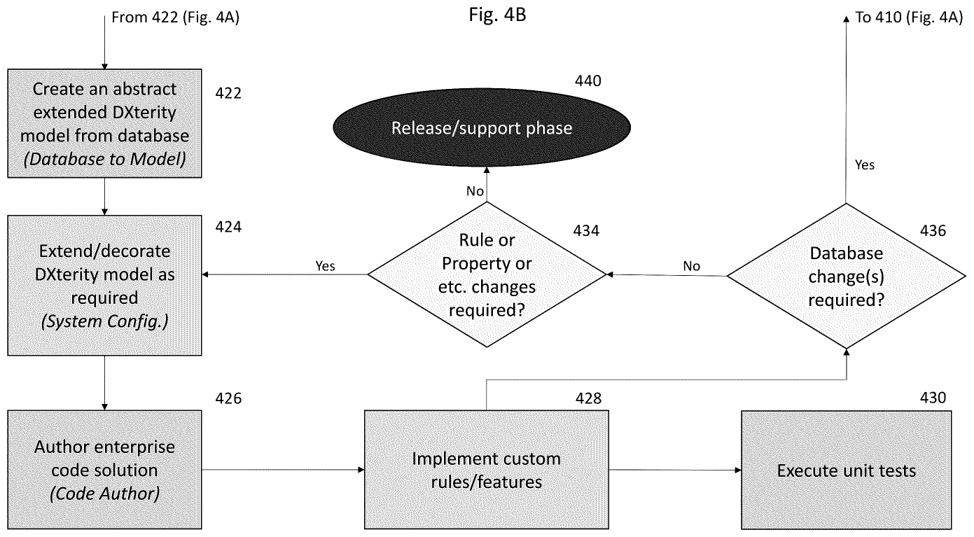

FIGS. 4A and 4B are a more detailed process flow of a typical analysis function 310. The process may start at state 401 to determine if a legacy database exists. If not, then state 402 may involve having a database architect perform a business analysis and in state 403 devise a logical model in state 404 from which a database is provided at 405.

In any event, state 410 is reached at which an input database exists. In this state, analysis of the database is performed (as will be described in detail below). The output of analysis is a database quality report 412.

Next, in state 414 a determination is made as to whether or not the quality report indicates the database passes a quality threshold.

If that is not the case then state 416 is entered where one or more resolutions (or scripts) identified by the analysis state 410 may be identified. In state 418 these scripts are presented to a developer who may optionally select one or more of the scripts to be executed against the database. Once these scripts are executed processing returns to state 410 where the database is analyzed again.

Once the database passes the quality test in state 414, state 422 is reached where the abstract model may then be generated from the database.

In state 424 the model may be further processed, for example, to author code at 426, to implement custom rules or features 428, or to execute unit tests 430.

If subsequent changes are required or detected, this may be handled at state 434 and 436. Finally, once these changes are satisfactorily resolved, the model may be released in state 440.

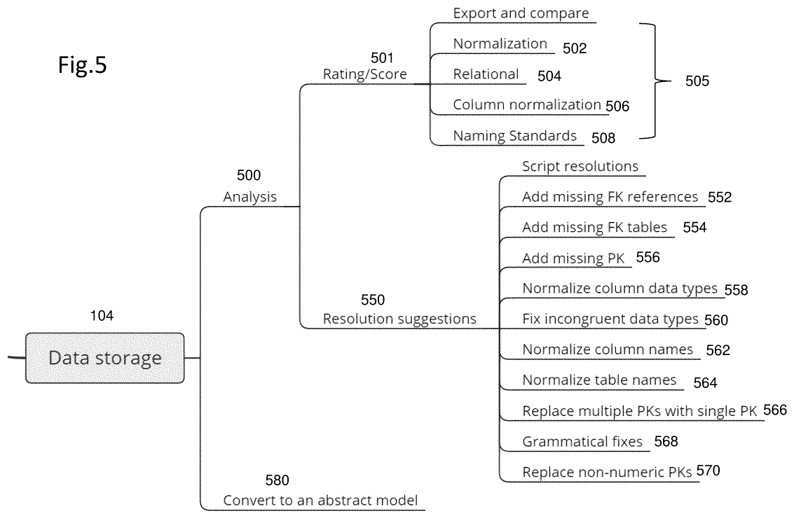

FIG. 5 illustrates possible analysis 500, scoring 501 and resolution 550 considerations in more detail. Scoring 501 may score the input data model 104 against one or more metrics 505. The metrics 505 may include normalization 502, relational attributes 504, column normalization 506 or naming standards 508. More generally, the analysis may involve determining whether or not the database is observing preferred enterprise class criteria such as proper naming conventions, structure conventions, normalization forms, amenability to relational predicate logic and so forth.

As mentioned previously, artificial intelligence in the form of a machine learning engine may also use the quality metric to aid the selection and/or creation of one or more scripted resolutions. For example, the resolution step 550 may include the machine learning engine may automatically try number of different scripted solutions until the quality metric is optimized.

More generally, various machine-learning structures may identify “the best” scripted solution. For example, in some embodiments, the resolution step 550 may utilize supervised learning from historical data that tracks which scripted solutions were best for given anomalies over time. A technical benefit is therefore obtained by segmenting the different detected anomalies and then utilizing the optimized machine learning engine to rapidly determine the ideal scripted solutions.

Corresponding resolutions, associated with the metrics 505, may be proposed in state 550. Scripted resolutions may include, for example, adding missing foreign key references 552, adding missing foreign key tables 554, and missing primary keys 556, normalizing column data types 558, fixing an incorrect data types 560, normalizing column names 562, normalizing table names 564, replacing multiple primary keys with a single primary key 566, grammatical fixes 568 and for replacing non-numeric primary keys 570. It should be understood that other resolution suggestions are possible it should also be understood that other ratings analysis metrics may also be implemented. Only after the quality score at analysis 500 reaches a threshold is the conversion step 580 allowed to proceed.

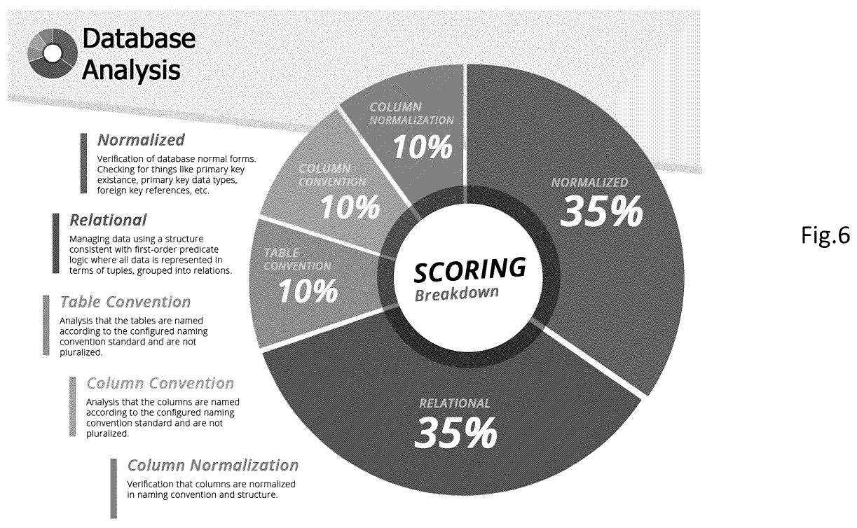

FIG. 6 is an example of how the analysis may generate a weighted score from the metrics 505. In this particular example, the architect has determined that normalization forms (for example checking things like primary key existence, primary key data types and foreign key references) should be weighted at 35% of the total. Relational-related metrics such as whether structures are consistent with predicate logic, or grouped into relations) should also be given a 35% weight. Table and column conventions are each respectively given a 10% weight and column normalization issues given a 10% weight.

The scoring metric may count the total number of metrics 505 (anomalies) of a particular type in the database, and then weight that count according. For example, a given database analysis may count anomalies in at least each of the following areas resulting in a score of 0.8 in normalization form quality, 0.6 in relational quality, 1.0 in table convention quality, 0.3 in column convention quality, and 0.4 in column normalization quality. The scores from each quality area may then be calculated as a weighted score such as:

| | | | | | | |
|---|---|---|---|---|---|---|
| 0.35 | 0.35 | 0.10 | 0.10 | 0.10 | | Weighted ratios |
| 0.80 | 0.60 | 1.00 | 0.30 | 0.40 | | Individual scores |
| 0.28 | 0.21 | 0.10 | 0.03 | 0.04 | 0.66 | Final score |

to obtain a final score of 0.66 out of a best possible 1.0, then expressed as a percentage to the developer.

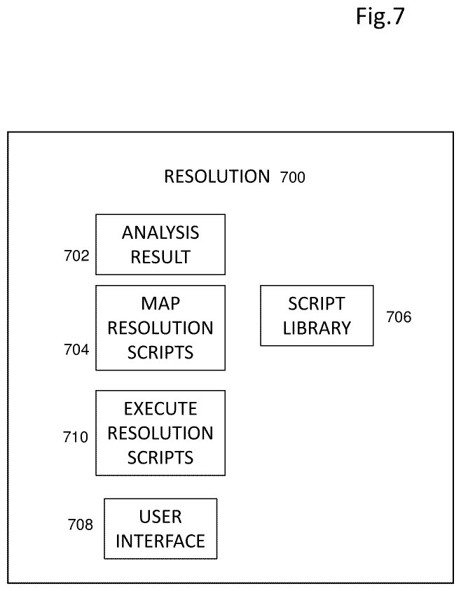

FIG. 7 is an example of the components of DXterity that may implement the resolution function 416. Resolution takes any resulting issues (or anomalies) determined in the analysis 702 and maps 704 appropriate scripts from a script library 706. The scripts may be presented via a user interface 708 where the developer may determine whether or not to execute 710 selected ones of the resolution scripts. It should be understood that, for example, a given database may have multiple naming convention anomalies. If the developer chooses, she may decide to resolve only some of those anomalies instead of all of them. Generally speaking, anomalies may include relational, normalization, column normalization, table convention, or column convention anomalies.

It should also be understood that the analysis may detect certain anomalies that are not amenable to automatic resolution. In this instance the fact of such anomalies may be presented to the developer at 708 for manual resolution. It is estimated that for most situations, the percentage of anomalies that are not auto-correctable will be relatively low actually, on the order of 10 to 15%.

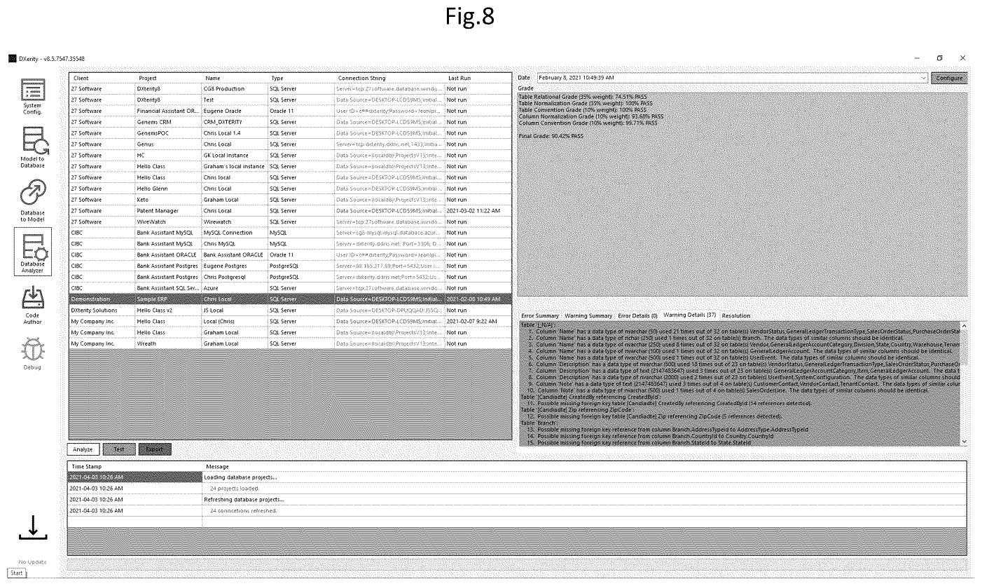

FIG. 8 is an example of an interface that may be presented to a developer to report the analysis result. Here, 37 warnings, shown on the bottom right of the screenshot, have been generated. The interface may permit the developer to scroll through and further examine these. Note that for example there were three missing foreign key column references (items 13, 14 and 15). Note that a corresponding script will be identified needs resolve each of the three missing references.

Although the analysis here is generated as a user interface, it should be understood that the analysis result may also be generated in other ways such as an HTML file.

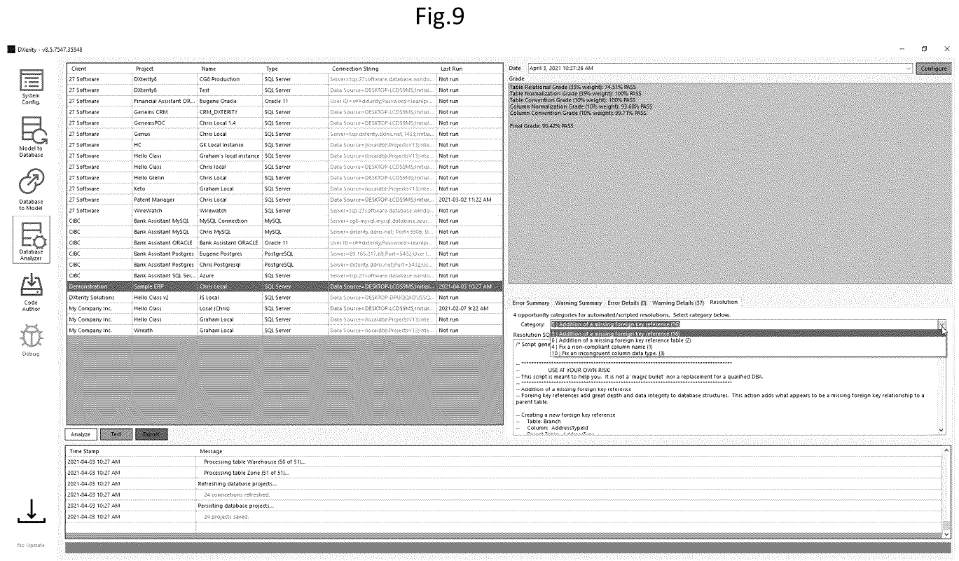

FIG. 9 is an example of how the developer may view the details of a resolution script prior to its execution. Here the developer is investigating warning number 4, which was a non-compliant column name. A proposed script for renaming the non-complaint column name is presented to the developer for their review. At this stage the developer may approve the automatically generated script or they may reject it. Note the script is generated based on the technology implemented in the database (here being SQL Server).

Other features of the user interface may permit configuring which anomalies should be detected. For example, a developer may not wish DXterity to be concerned with pluralization issues in a certain database. These may be set in the configuration option 700.

It is also the case that analysis results may be versioned. In particular, the system may retain a history of all generated analyses for a database including warnings and proposed resolutions, to permit subsequent comparative analysis. Having a history of implemented resolutions may further assist the developer in implementing corrections.

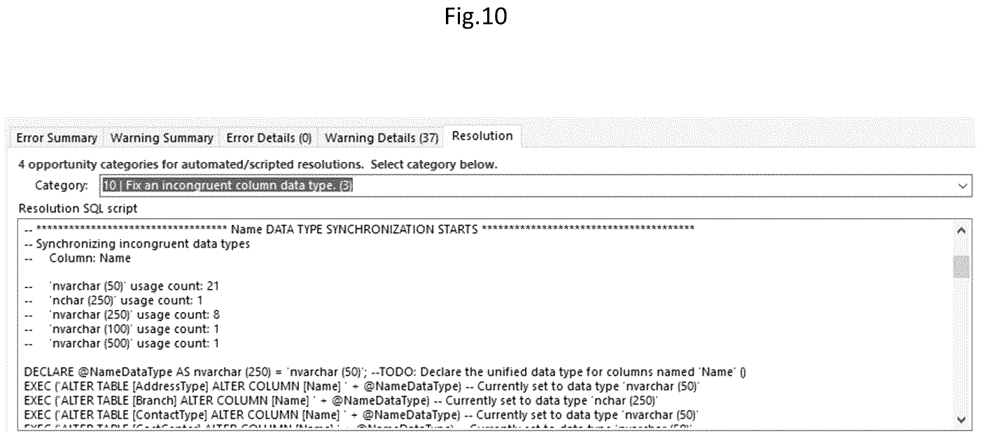

FIG. 10 is another user interface screen which may be viewed when resolutions are executed. Here the system is reporting to the developer that it has added missing foreign key reference for a table, corrected a column name, and fixed three instances of an incongruent column data type.

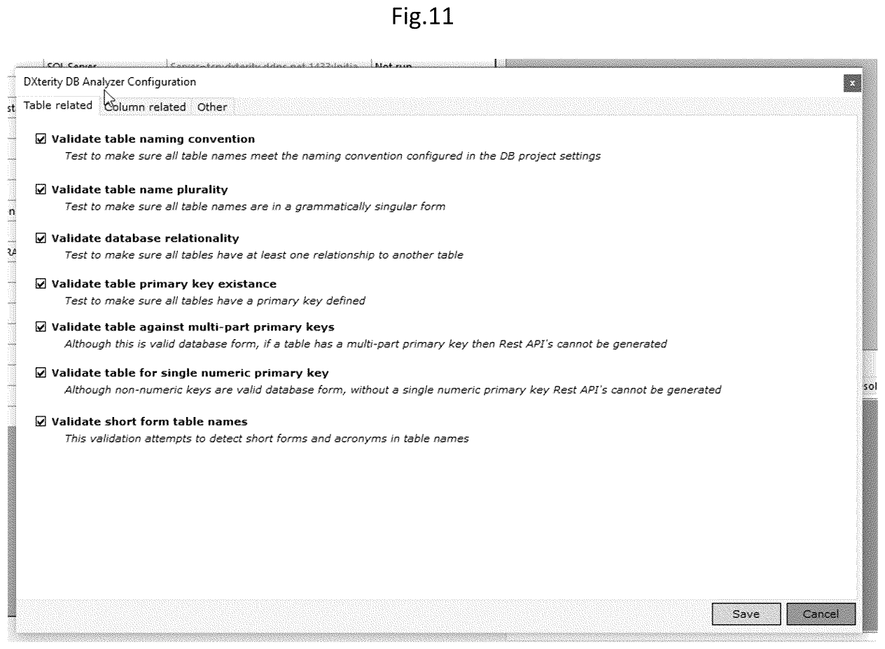

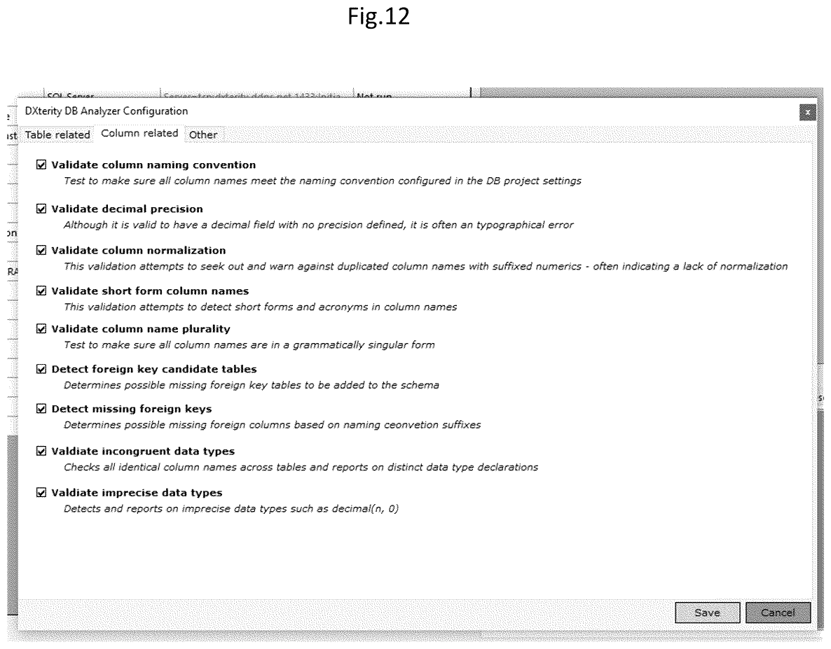

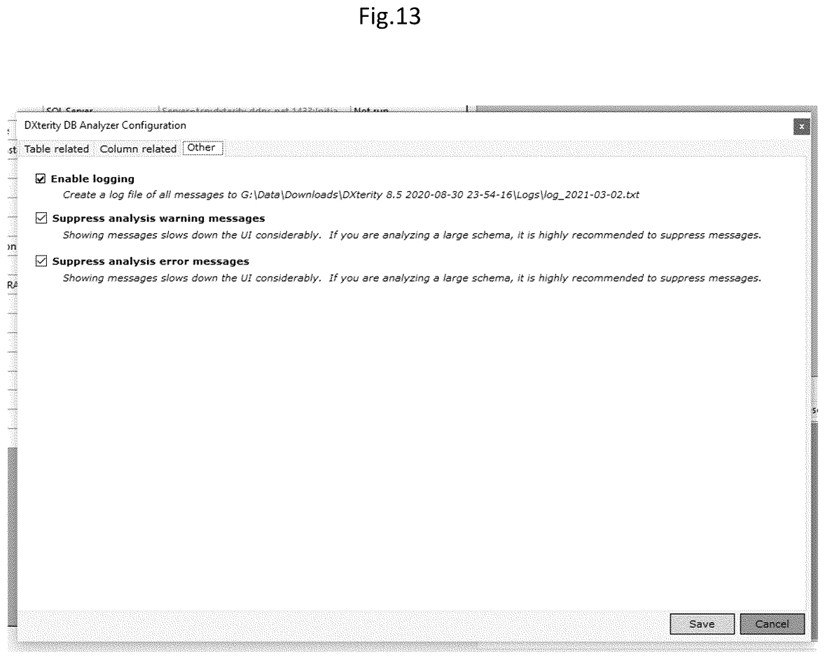

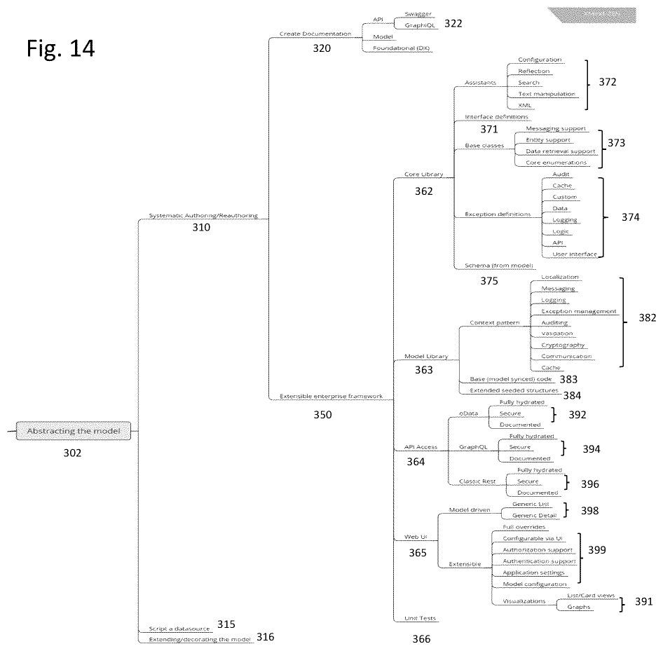

FIGS. 11 through 13 are example interface screen where the configuration options 700 for the database analyzer may be set by the developer. Some possible configuration options 700 include:
Validate table naming convention (make sure all table names meet a predetermined naming convention)
Validate table name plurality (make sure table names are in a grammatically singular form)
Validate database relationality (make sure all tables have at least one relationship to another table)
Validate table primary key existence (make sure all tables have a primary key defined)
Validate table against multi-part primary keys (although a valid database form, if a table has a multi-part primary key, then warn developer Rest APIs cannot be generated)
Validate table for single numeric primary key (although non-numeric keys are valid database form, without a single numeric primary key, then warn developer Rest APIs cannot be generated)
Validate short form table names (detect short form names or acronyms in table names)
Validate column naming convention (make sure all column names meet the naming convention configured in the project settings)
Validate decimal precision (Although it is valid to have a decimal field with no precision defined, it is often a typographic error)
Validate column normalization (seek out and warn against duplicated column names with suffixed numerics, which often indicate a lack of normalization)
Validate short form column names (attempts to detect short forms and acronyms in column names)
Validate column name plurality (make sure all column names are in a grammatically singular form)
Detect foreign key candidate tables (determine possible missing foreign key tables to be added to the schema)
Detect missing foreign keys (check for possible missing foreign columns based on naming convention suffixes)
Validate incongruent data types (checks all identical column names across tables and reports on distinct data type declarations)
Validate imprecise data types (detects imprecise data types such as decimal (n, O))
Enable logging
Suppress analysis warning messages
Suppress analysis error messages
   II. Automated Authoring of Software Solutions from a Data Model

### System Overview Review

As explained above, the present invention relates to a system and methods that may consume a data source and transform it into an abstract model. The abstract model may be extended and then automatically translated into generated base code, Application Programming Interfaces (APIs), User Interfaces (UI), documentation, and other elements. Each of the generated base code, generated base APIs and generated base UIs may be extended. Extended elements are maintained in a framework, such as a different source code file, separately from generated based code elements.

Of specific interest herein is that attributes, properties and other decorations may be applied and revised to the entities and relations in the abstract model. Code may then be automatically re-generated without disturbing any extended or customized code. This enables late binding on such decorations that may be stored in a configuration file. In other words, the UI and even attributes and properties of entities may be re-generated and deployed continuously and dynamically.

The data architect, developer, or other user of the DXterity platform may choose a desired language or architecture of the API (e.g., OData, GraphQL, or REST). Similarly, code for the UI may be generated as JavaScript or in some other available language.

The generated documentation may take the form of an English or other spoken language interpretation of the generated code. For example, the documentation may consist of interpreted GraphQL.

An example implementation will now be described and shown, starting with FIG. 1. Here a data source, such as data store 102, is made available to a code generation tool or platform 100 (also referred to herein as the DXterity platform). The data store 102 may for example be a database associated with a legacy software application. The data store 102 may be in any common form such as MySQL, SQL Server, DB2, Oracle, Access, Teradata, Azure, PostgreSQL or the like. The DXterity platform 100 is used to generate an abstract model 104 from the input data store 102. The abstract model 104 is then fed to an author 106. The author 106 automatically consumes the model 104 to generate and regenerate code to match the model 104. The author may generate the code in certain forms, and also generate other artifacts related to the model 104. For example, the author 106 may generate or use a core code library 122 and model library 124. But the author may also generate application base logic, a web application interface 126, a user interface 128, unit tests 130, and documentation 132 from the abstract model. The input source may describe the data in a database in other ways, such as via an entity relationship diagram, as explained in more detail below.

The abstract model is generated in a particular way to help ensure that the resulting code 122, 124 conforms to expected criteria. For example, DXterity 100 may be configured to ensure that the resulting generated code and artifacts 122-132 provide an extensible, enterprise-class software solution with late binding on UI and API elements. As will be understood from the discussion below, this is accomplished by ensuring that the abstract model itself conforms to certain metrics or conventions prior to code generation.

Enterprise class software, is computer software used to satisfy the needs of an organization rather than individual users. Enterprise software forms integral part of a computer-based information system that serves an organization; a collection of such software is called an enterprise system. These enterprise systems handle a chunk of data processing operations in an organization with the aim of enhancing the business and management reporting tasks. The systems must typically process information at a relatively high speed and may be deployed across a variety of networks to many users. Enterprise class software typically has, implements or observes many of the following functions or attributes: security, efficiency, scalability, extendability, collaboration, avoidance of anti-patterns, utilization of software patterns, architected, designed, observes naming and coding and other standards, provides planning and documentation, unit testing, serialized internal communication, tiered infrastructure, exception management, source code and version control, and includes interfaces for validation, messaging, communication, cryptography, localization, logging and auditing.

FIG. 2 illustrates an example implementation in a bit more detail than FIG. 1. Here there are two input data stores 102-1, 102-2, respectively associated with two legacy systems including an IBM mainframe 140-1 running a DB2 instance 141-1 and an SAP/ERP application accessing an Oracle database 141-2.

The DXterity platform 100 consists of an analyzer component 200 and a schema modelling component 212. The schema modelling component 212 generates abstract models of the legacy databases 141-1, 141-2.

The analyzer component 200 analyzes the abstract models of the legacy databases 141-1, 142-2 against selected metrics, generates a score, and recommends resolutions to improve the scores.

A standardized database schema is then output from DXterity 100 as a meta model 214. The meta model 214 may then be re-platformed in various ways. For example, it may be migrated to an on-premise modern database 220. Or the meta model may be migrated to a cloud provider 222 or as a cloud service 224.

Artifacts generated by DXterity 100 may also be fed to other related functions, including an application development platform 230 that drives DevOps pipelines 232, or integration/orchestration environments 234 that support specific application development platforms 236.

Also, of interest is that the DXterity platform 100 may be used to generate its result as data-as-code (e.g., as .NET, or Java), data-to-container (e.g., as a Docker file), or data-as-API (REST, OData, GraphQL, etc.).

II. Characteristics of the Code Authored from the Abstract Model

FIG. 3 is one example of a hierarchical list of the functions, structures, and concepts that may be performed or authored by the DXterity platform 100.

An abstracting function 302 takes the physical model and generates an abstract model.

From the abstract model, then systematic authoring/re-authoring functions 310 may proceed. Systematic authoring 310 consists of automatically generating the extensible enterprise framework as executable code 350 as well as creating the related documentation 320.

Other functions or operations such as scripting a data source or extending 315 and decorating 316 may also be performed on the abstract model.

The generated extensible framework 350 architects the authored (generated) code in a particular way. More specifically, the code generated may be arranged into a core library 362, model library 363, API access 364, web UI 365 and unit test 366 elements.

In an example implementation, the core library 362 may further include code grouped as assistant functions 372 (including configuration parameters, reflectors, search, text manipulation, and XML), interface definitions 371, base classes 373 (including messaging support, entity support, data retrieval support, or core enumerations), exception definitions 374 (including audit, cache, custom, data, login, logic, API, and user interface, as well as schema definitions 375.

The model library 363 may involve generating context patterns 382 (including localization, messaging, logging, exception management, authoring, validations, cryptography, communication and caching), base code 383, and extended structures 384.

API access 364 may be generated in any of several API formats including OData 392, GraphQL 394, or REST 396 each of which may be accordingly hydrated, secure and documented.

The generated web UI 365 artifacts are also driven 398 from the abstract model in which case generic list and generic details are provided; or they may be extensible 399 (including overrides, configurations, authorization and authentication support with application settings 399 and/or model configurations and/or visualizations 391.

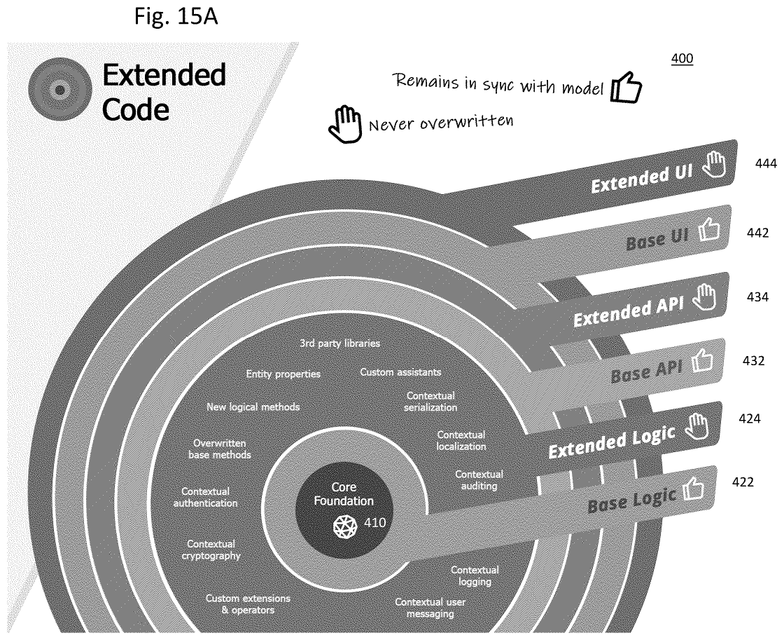

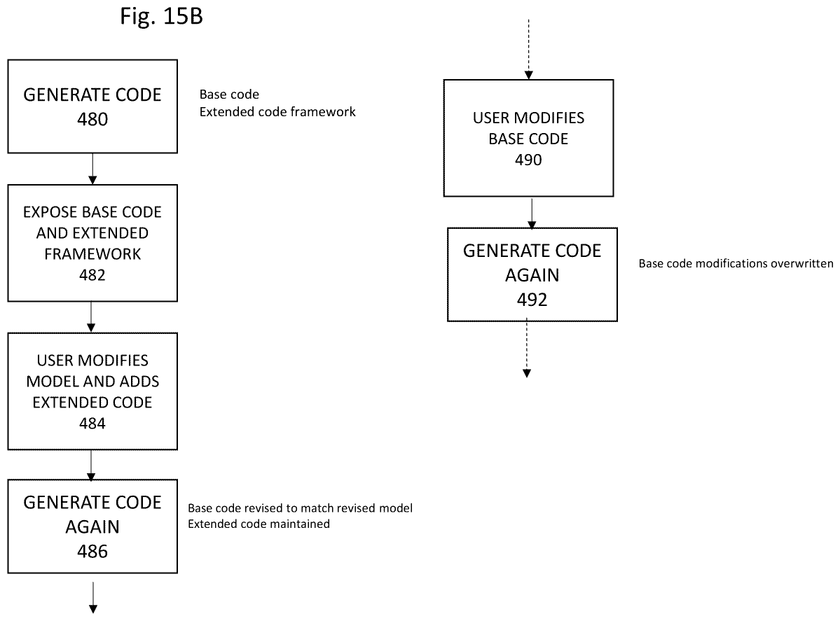

FIG. 15A illustrates the hierarchy of the generated code. More particularly, the generated code is divided into a core code foundation 410, and application-specific logic including base logic 422 and extended application logic 424. API code is also arranged as base API code 432 and extended API code 434. Web UI code similarly includes base UI code 442 and extended UI code 444. The different code elements including base application logic 422 and extended application logic 424 are stored separately from one another, such as in different files. Similarly, base 432 and extended 434 API code are stored separately from one another, as are Web UI base 442 and extended 444 elements.

As mentioned previously, the core code 410 consists of elements that are used by more than one application or solution. For example, the core code may include common libraries and similar functions.

The base components specific to the application, such as base logic 422, base API 432 and base UI 442 are automatically generated from the abstract model and always remain in sync with the model. Therefore, even though the developer is permitted to view and even edit the base application code 422, base API code 432 and Web UI base code 442, these base components will be rewritten whenever the developer requests code to be re-generated from the model.

The generated structures (or frameworks) may be used by the developer for placement of extended code including extended application code 424, extended API code 434 and extended Web UI code 444. These frameworks may thus be exposed to a developer for review (such as a data architect) and also made available for modification. These extended code elements, once modified, are not permitted to be overwritten by any subsequent automated regeneration of code. However, in some implementations, the extended code elements may be permitted to be overwritten before any developer modifications are made to them. In some implementations, extended UI code may be stored in a configuration file to, for example, enable late binding as explained elsewhere.

As also shown in FIG. 15A, patterns implemented by the extended code components may include a variety of methods and properties supplied by the developer. As the figure suggests, these may include overwritten base methods or entity properties, third party libraries, new logical methods, contextual serialization or context localization, contextual cryptography authentication, contextual user messaging, logging, auditing, custom extensions or operators. Again, these may be stored as part of the extended logic 424 or other components such as extended API 434 or extended Web UI 444.

As can now be appreciated, an example flow might be as shown in FIG. 15B. At step 480, the model is used to generate base application code that is stored separately from an extended application code structure. The base application code and extended application code structure are then exposed at 482 for access by and review by the developer. Modifications and/or additions may also be made by the developer to extended application code structure at 484. Also at this stage, the developer may even directly modify the base application code that was generated from the model at 484. Indeed, the developer may even decide to modify the model at this stage.

However, subsequent regeneration of code at step 486 based on the model will generate new base application code from any revisions to the model, thus overwriting any modifications that the developer had directly made to the base code. The code regeneration step preferably will, however, be prevented from overwriting any modifications the developer made to the extended code.

Note too that at some later time (step 490) the user may modify the base application code directly. After another code generation step 492, any modifications made to the base code in step 490 will be overwritten. This then ensures that the base code always conforms to the model—and does not include any modifications made directly to the base code by the developer.

### III. Physical Model Sources and Examples

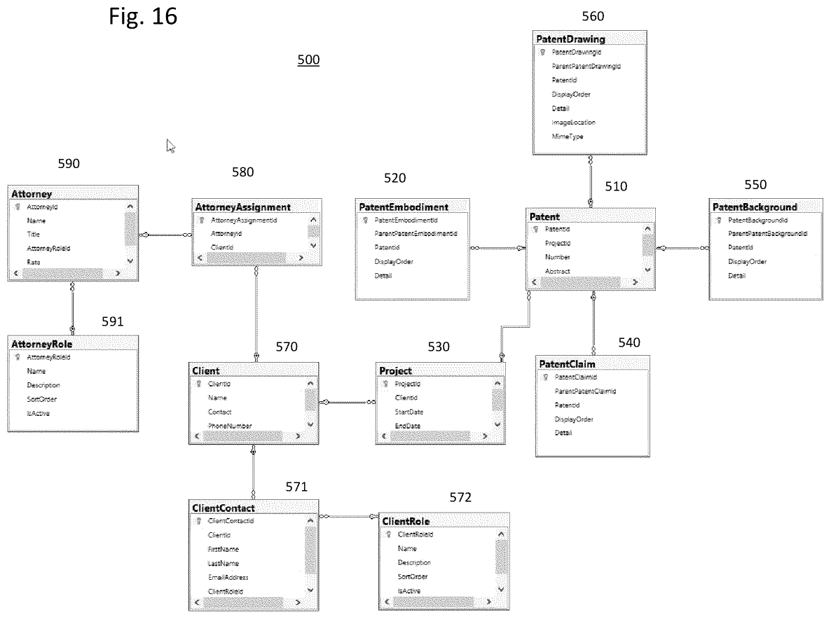

FIG. 16 is an example of a physical model 500 provided as input to the DXterity platform 100. The physical model 500 may originate in a number of ways. For example, it may be generated by an entity relationship graphical tool such as Cacoo or ERDPlus. In other instances, the physical model may be generated from existing legacy database code. In one example, the legacy database is an Oracle database running on an IBM mainframe, and the DXterity platform 100 may include data discovery components capable of interpreting the physical legacy database such as Oracle SQL Developer or Dataedo. In still other instances, a diagram or other representation of the physical model may originate by hand on a whiteboard or paper that are then used to specify tables and other attributes of the abstract model.

The diagram of FIG. 16 represents data stored in the database and relationships between data. In other words, the diagram is illustrative of the logical structure of the data including real world entities, their attributes and relationships among entities. As is well known, the diagrams are translatable into tables which may be used to build a database.

This example physical model 500 supporting a patent/legal operation where attorneys are performing projects for clients where the projects consist of preparing patents. The physical model 500 thus consists of attorney entities 590, project entities 530, patent entities 510 and client entities 570.

An example entity such as the patent entity 510 has attributes including a patent identifier, a project identifier, a patent number, an abstract, and so forth.

The patent entity 510 also has relationships with a project 530, patent claims 540, a patent background 550, patent drawings 560, and patent embodiment 520. The attorney entity may also be related to an AttorneyRole 591 and, Attorney Assignment 580. The Client entity 570 may have related ClientContact 571 entity and ClientRole 572 entity.

In another example application, such as one used by a university, database entities might be provided for students, courses, and instructors. Entities are represented by their properties which are also sometimes called attributes. The student entity could have attributes such as a student ID number, student name, and department ID, with the student entity having relationships with courses and instructors. Attributes may have separate values. For example, a student entity might have a name, age, and class year as attributes. An example student relation may indicate that a student named “Tom Smith” is taking a course called “organic chemistry” being instructed by “Professor Jones”.

### IV. Abstract Model View, Properties and Attributes

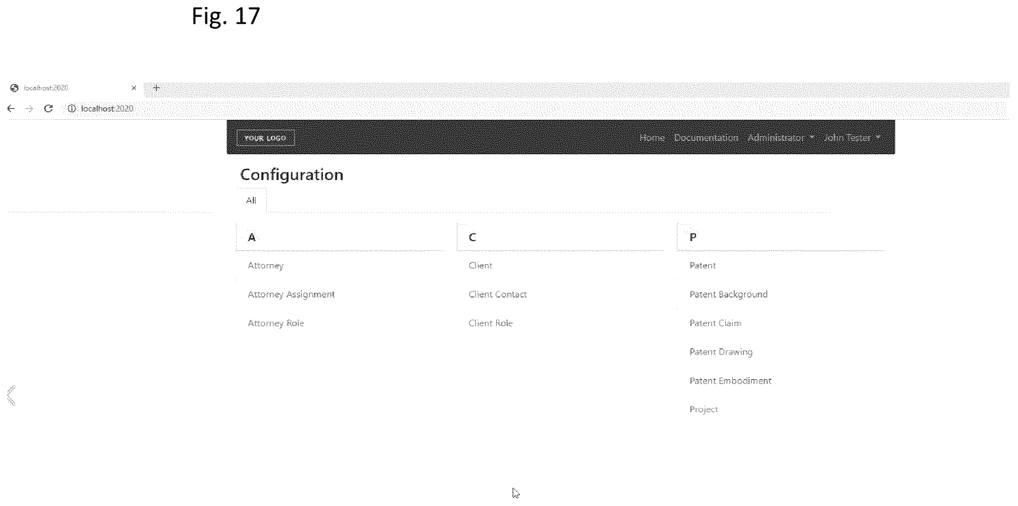

As was mentioned in connection with FIG. 1, the physical model 500 is submitted to the DXterity platform 100 which then generates an abstract model 104. At this point, the developer who may be a database architect is presented with a user interface such as shown in FIG. 17 to view the abstract model 104. Note that each of the entities of FIG. 16 are represented in the user interface at a high-level. At this point, the developer may click on one of these entities to examine more information about its attributes and relationships.

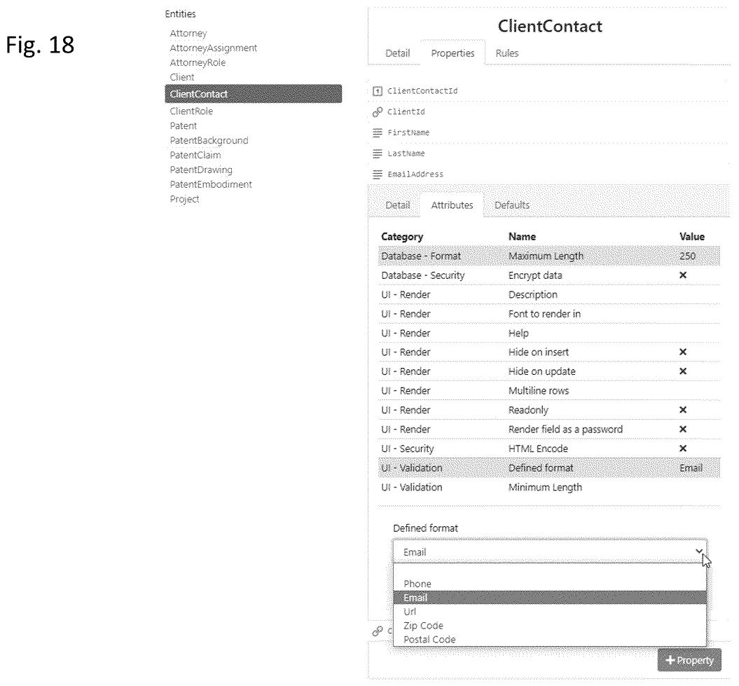

FIG. 18 is an example where the developer has clicked on the ClientContact entity and is now presented with more details of that entity. For example, the developer may see that it has a client contact ID attribute, and that it has a relationship with a client ID. The ClientContact entity also has attributes such as a first name, last name and email address. The ClientContact has decorations and properties such as a format property as “being limited to 250 bytes”, and a security property of “not encrypted”. Other examples are possible.

Also, important to note here is that the attributes associated with the ClientContact entity may include user interface attributes. These may include attributes of how to render the entity in a user interface (such as the font to use, or whether it should be hidden on insert or update, or whether a help field is displayed), whether it is read only or consists of multiple rows. Other attributes may pertain to how the UI may handle input validation. For example, selected input attributes may be required to have a certain minimum length or format (such as a password, or such as an email address field must have a proper format with an “@” and a “.”). Still other attributes may relate to security within the context of the UI (e.g., it must be rendered in the UI via encoded HTML).

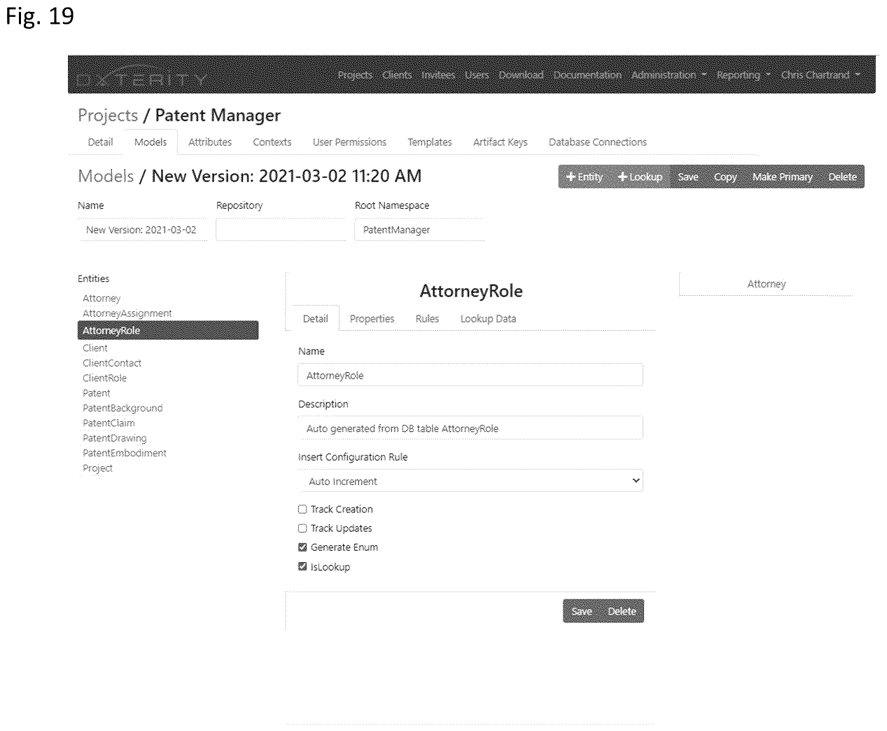

FIG. 19 is an example of an entity called “AttorneyRole” that was defined as being restricted to enumerated values. Here the entity may only take on one of two possible values, representing either a lead attorney or assistant attorney.

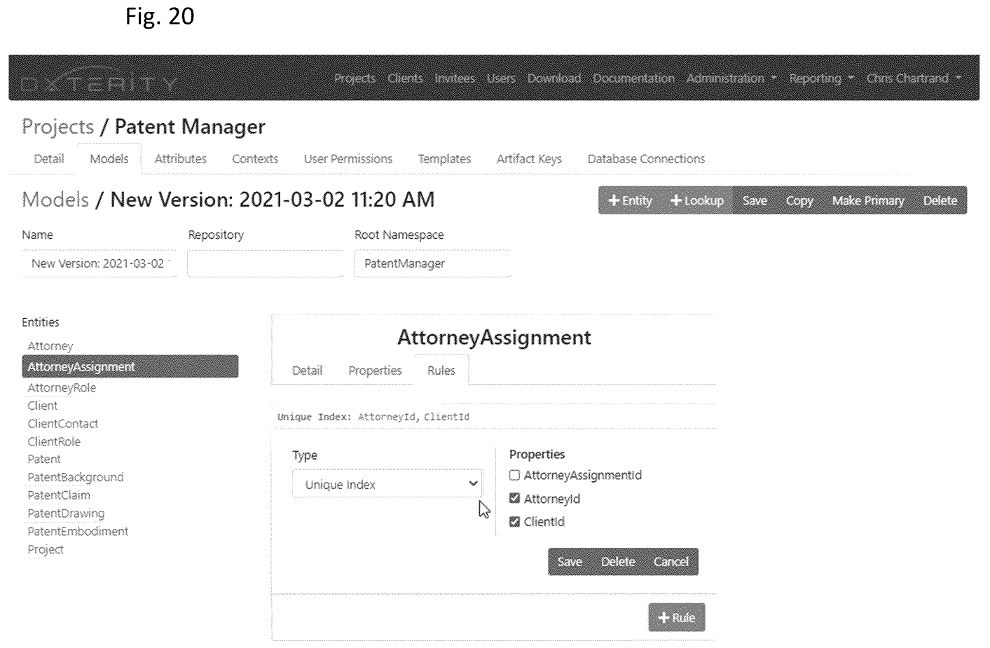

FIG. 20 as an example of how the abstract model represents a rule applied to an entity. Here the Attorney Assignment has an associated rule that requires it to always have an both a clientID and attorneyID relation.

Rules, properties and relations may be used to ensure that the resulting code conforms to desired characteristics of enterprise class code. For example, a uniqueness requirement may be imposed on a set of objects such as the first name, last name, and email address associated with an attorneyID. In another instance, an encryption requirement may be imposed on a certain field type regardless of where it appears in the model, such as a credit card number or social security number.

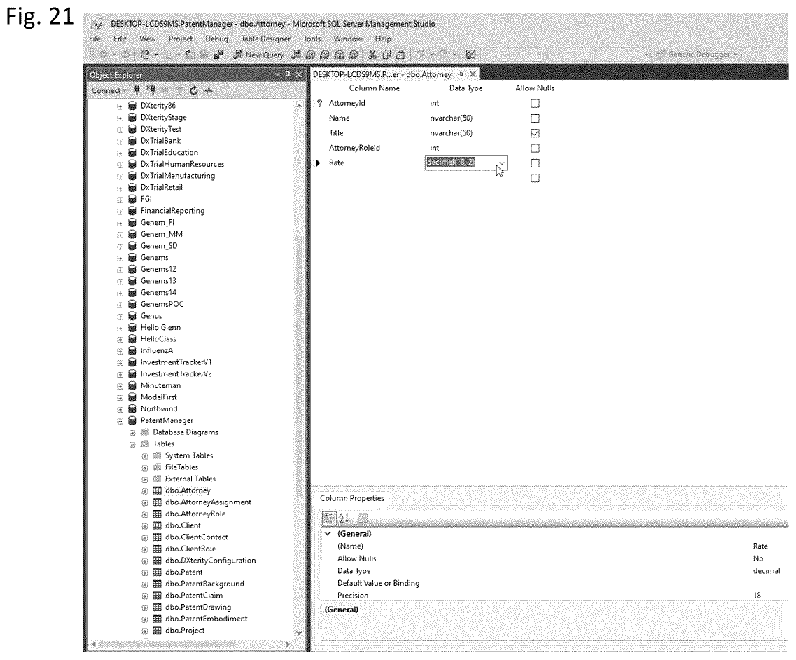

FIG. 21 is another example of a user interface screen where database designer views has manually overridden a data type which the model originally assigned to an attorney billing rate.

Therefore, it should be noted that in these various figures just described, the database architect is using an interface to define further decorations for the abstract model, prior to any code generation for the database code, API or UI. These may include defining various properties and relations of the entities in the model, as well as defining attributes of the related user interface and application programming interfaces for the same.

### V. Generated and Extended Code Examples

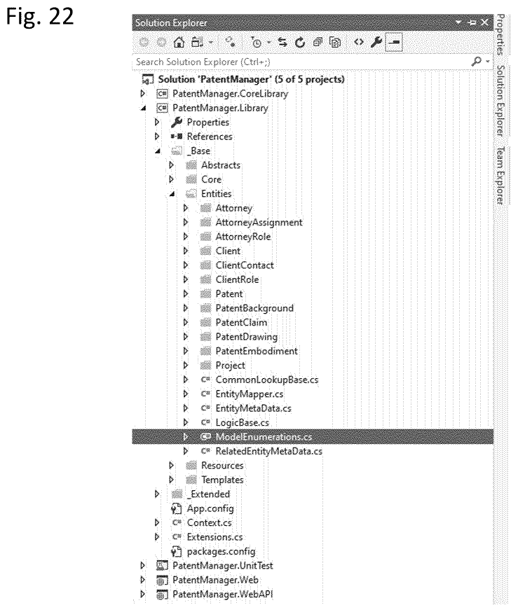

FIG. 22 is an example screen which may be presented after Author 106 generates code. It may be seen that the base logic 422 code has been generated and stored in separate “folders” for each of the entities in the patent attorney model. At this stage there is also a folder for placement of any future extended logic. A core library, web UI and web API code has also been as code artifacts separate from the base logic layer.

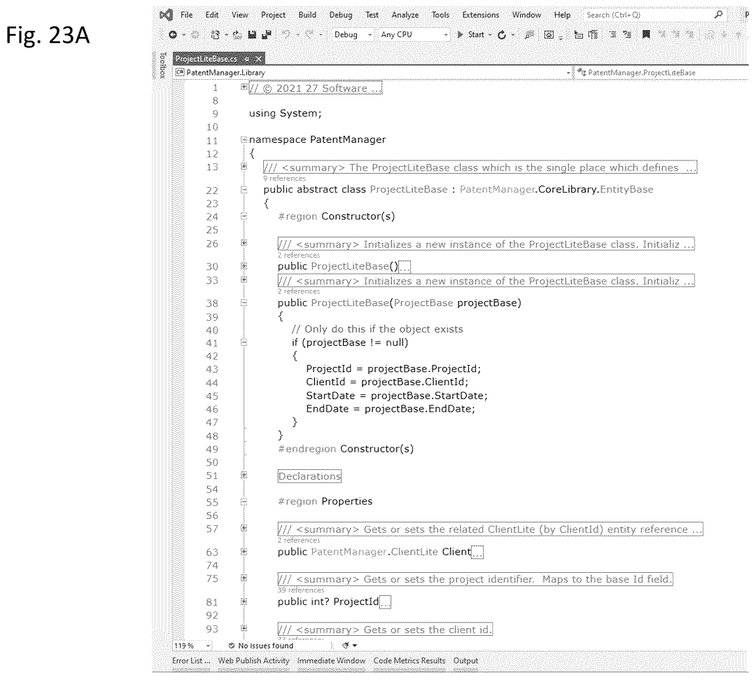

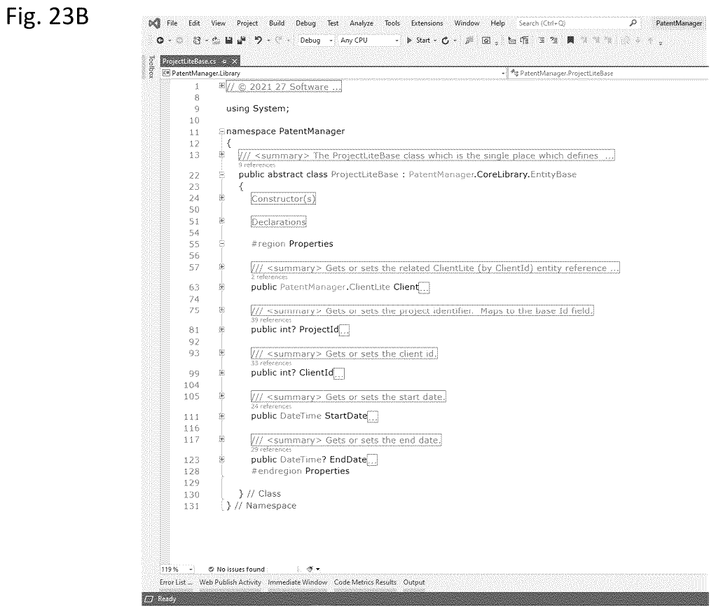

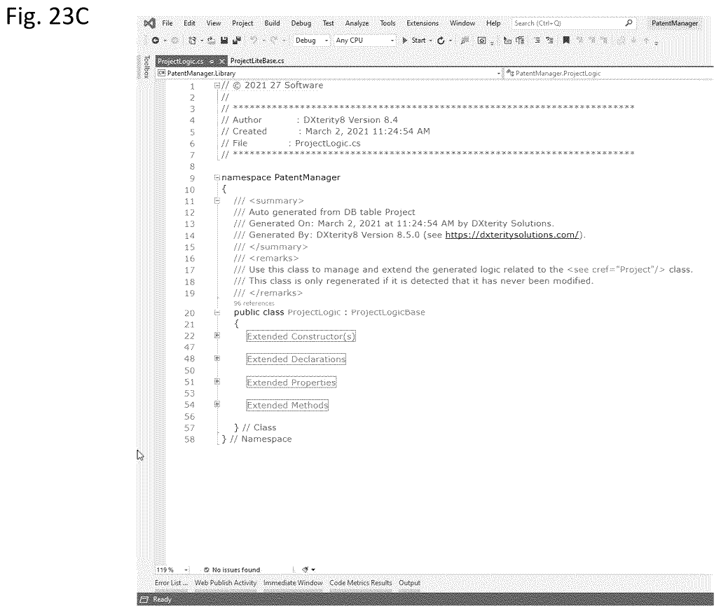

FIGS. 23A, 23B and 23C illustrate a more detailed example of generated code for a particular entity, the “Project” entity. FIG. 23A is part of the base code that serves as the constructor method for the Project entity. FIG. 23B is the code that defines its properties. FIG. 23C is an example of the code generated to serve as a location for any extended definitions of constructors, declarations, properties or methods related to the Project entity.

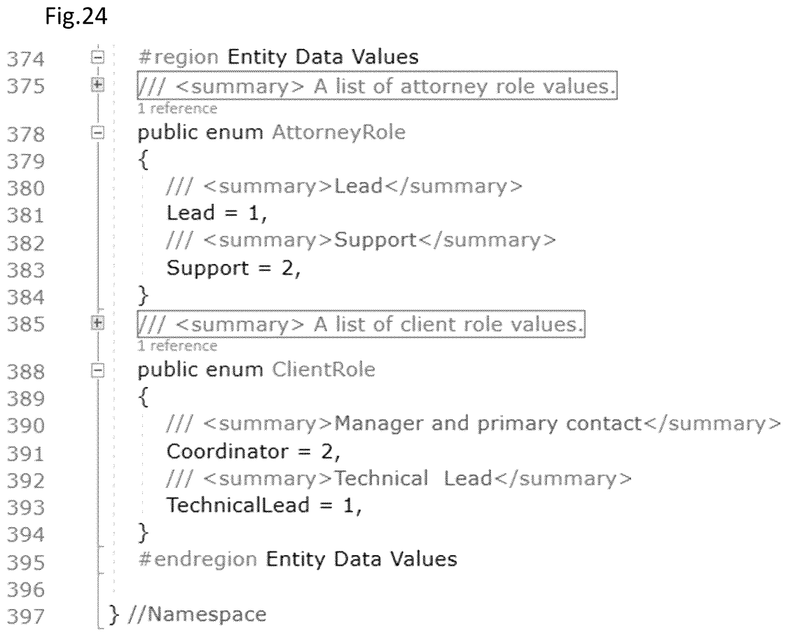

FIG. 24 is an example of database code generated for an entity limited to enumerated values. Here the “AttorneyRole” entity is seen to always be given either a value of one or a value of two, depending upon whether the attorney is a lead or support attorney. Also shown here is code for a “ClientRole” entity that enforces either a coordinator or a technical lead enumerated value.

As mentioned previously, this code is generated in a language specified by the developer (here SQL Server), although code may be generated in other database languages. Furthermore, the generated code including the base code remains exposed and visible to the developer to enable her to make changes typically as extended code. See the above description of the separation of generated and extended code.

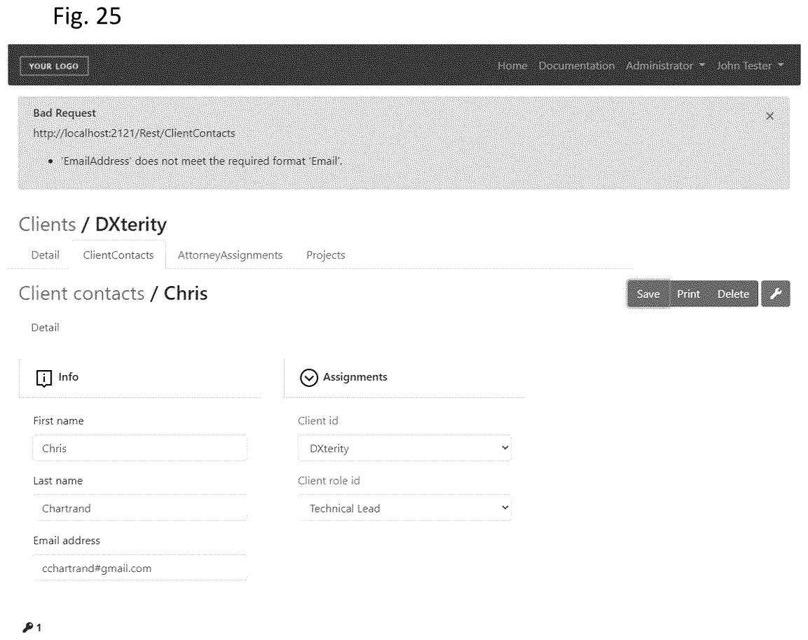

FIG. 25 is an example of an automatically generated web interface as might be accessed by an end user who is running the resulting code. In this example, the end user is entering information for a new ClientContact. While they have entered a first and last name, the email address entered did not conform to the attributes defined for that entity (e.g., FIG. 18). The generated web UI automatically catches this error and displays a help message to the user.

Keep in mind that the code to generate this web UI was automatically generated from the abstract model and during the same generation activity the underlying base logic for the application was generated.

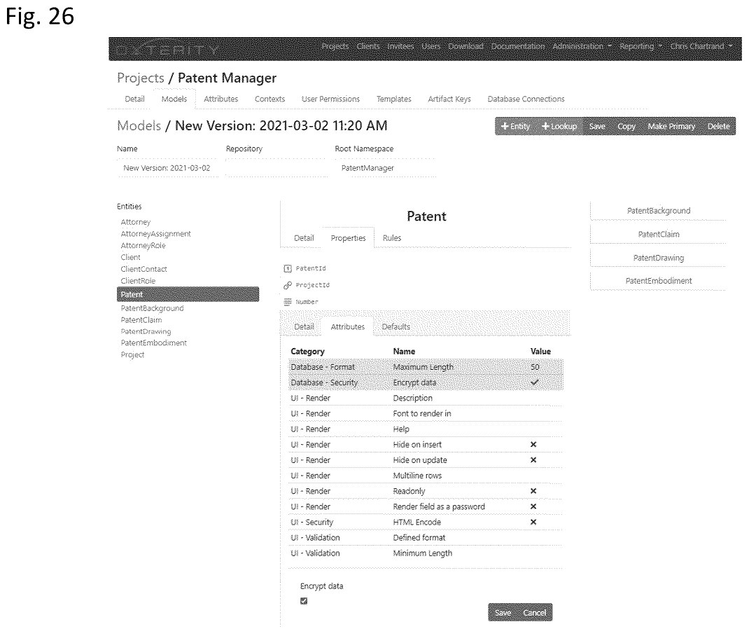

As explained above, the system is also capable of automatically adapting the generated base, UI and API code as the attributes and properties of entities are changed by the designer. In the example shown in FIG. 26, the architect has decided that the “Patent” entity should be revised to have a security attribute of “encrypted”. All that is needed is for the architect to go into the DXterity platform 100, select the checkmarks associated with database security, and then run the Author to regenerate the code.

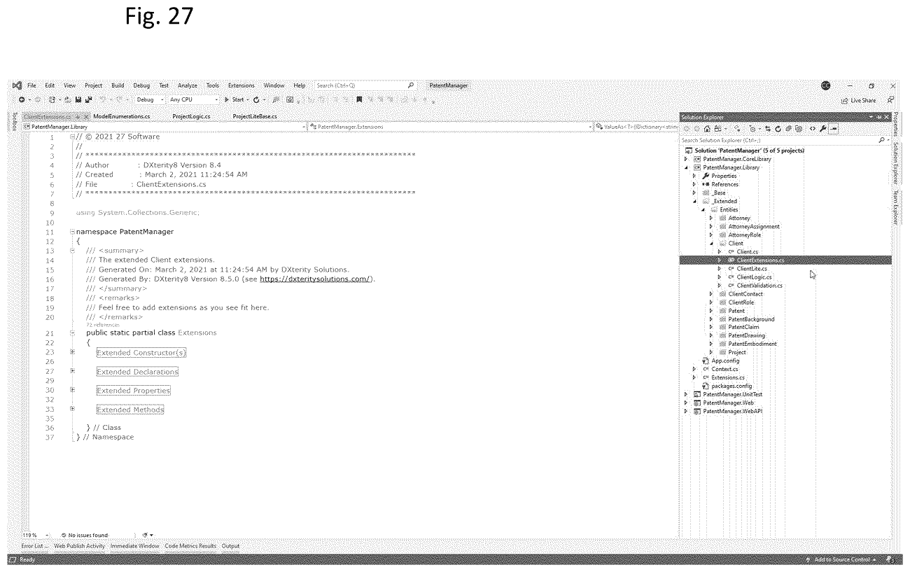

FIG. 27 shows the results of this. The resulting implementation of the encryption of the Attorney entity is not made to the base logic 422. Rather, that is stored as extended code logic 424.

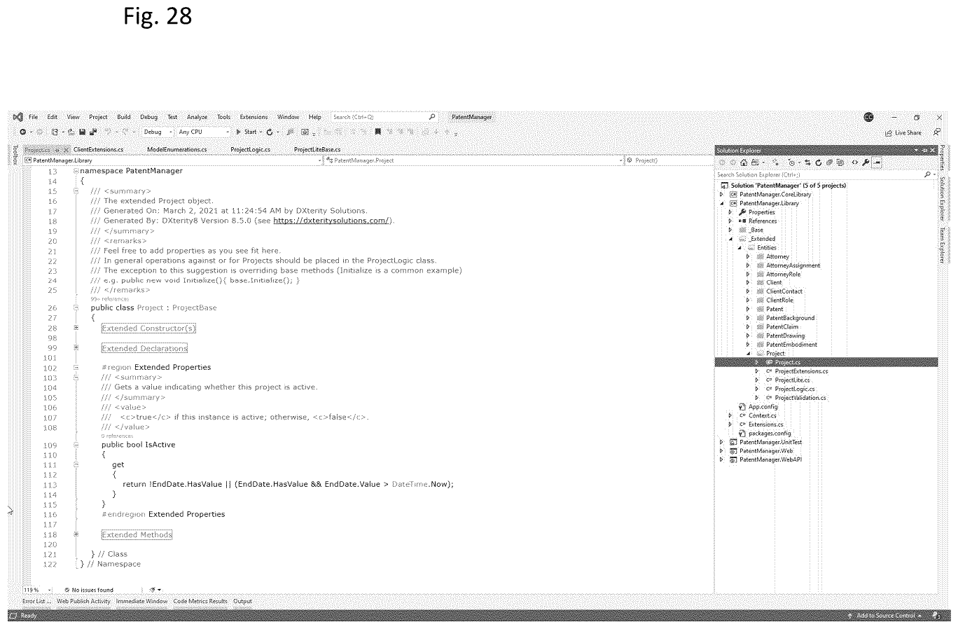

FIG. 28 is an example where a developer directly modifies generated base code 422. Again, the result is stored as an extension logic rather than as modification to the base logic. Here, while browsing the generated base logic, the database architect has decided that the Project entity should have an “Active” attribute that indicates whether an end date has been reached. The designer then defines an EndDate (in line 112) and provides a property that returns whether or not the EndDate value is greater than the current date. This modification to the code will now be stored as part of the project logic but as extended logic 424 that is separate from base logic 422. In this way, the system 100 always separates developer modified code from the base logic that is automatically generated from the model. As may be appreciated, this feature greatly assists with diagnosing problem areas or debugging the resulting code, since any developer modified sections which may deviate from the models may now be easily identified.

Base objects do not live independently. Each object lives in the context of all other objects, creating at least one hydrated object graph due to the platform's inherent ability to understand complex relationships. This allows all generated base code to intelligently interact with the model. Examples include the ability to comprehend all child and key relationships allowing for automatic intelligent retrieval of related data and the ability to recursively insert and delete data across all tiers; distinguishing between multiple and single relationships.

### VI. Example APIs

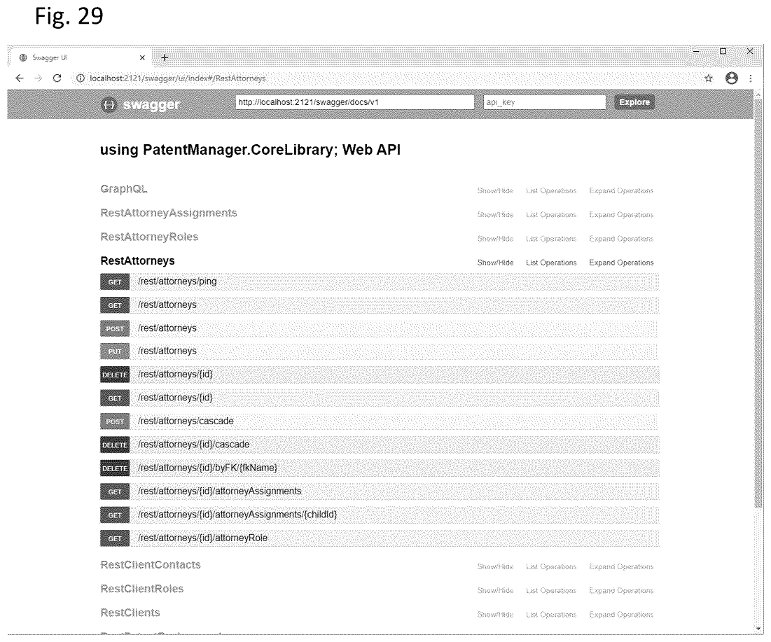

FIG. 29 is an example of a REST compliant API that may be generated from the model. The result was generated for a core library that implements the Attorney/Patent related application. Thus, the diagram included attorney roles, clients, patents and other entities as well. Here the architect may examine the attributes of the resulting API and test functions such as GET, POST, PUT, DELETE, and so forth.

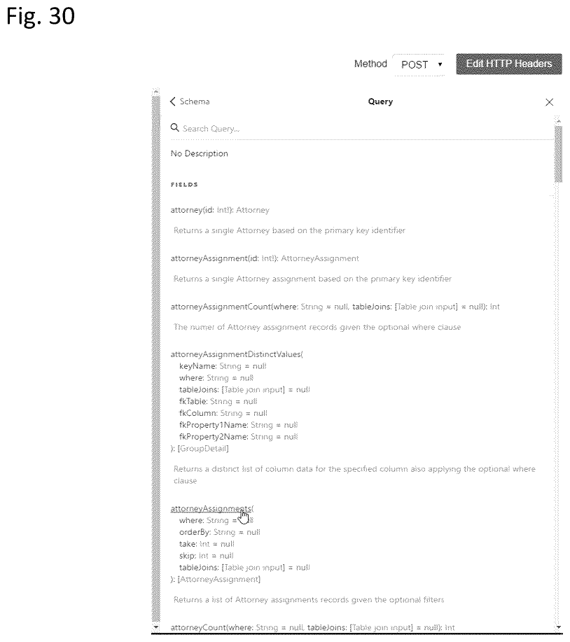

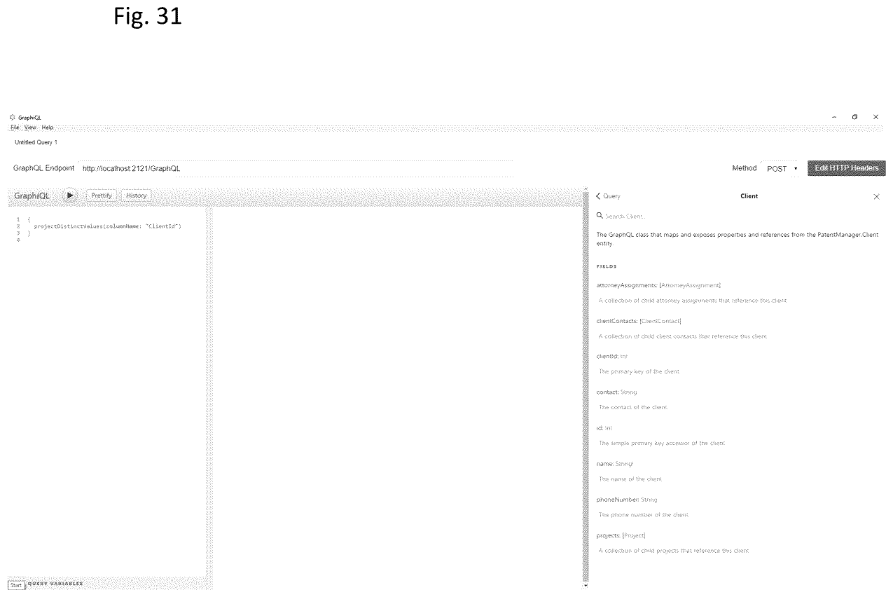

Another API example is FIG. 30 illustrating a GraphQL API and how it may be fully documented. A tool such as GraphiQL may be used to browse the generated API. In this example, the Attorney entity is seen to include a key name and other distinct values that define its properties or attributes. The related documentation in FIG. 31 was automatically generated at the same time the generated code was authored from the model. The documentation may be generated from abstract model and recognizing primary keys, properties, relations, descriptions, and other decorations of the model

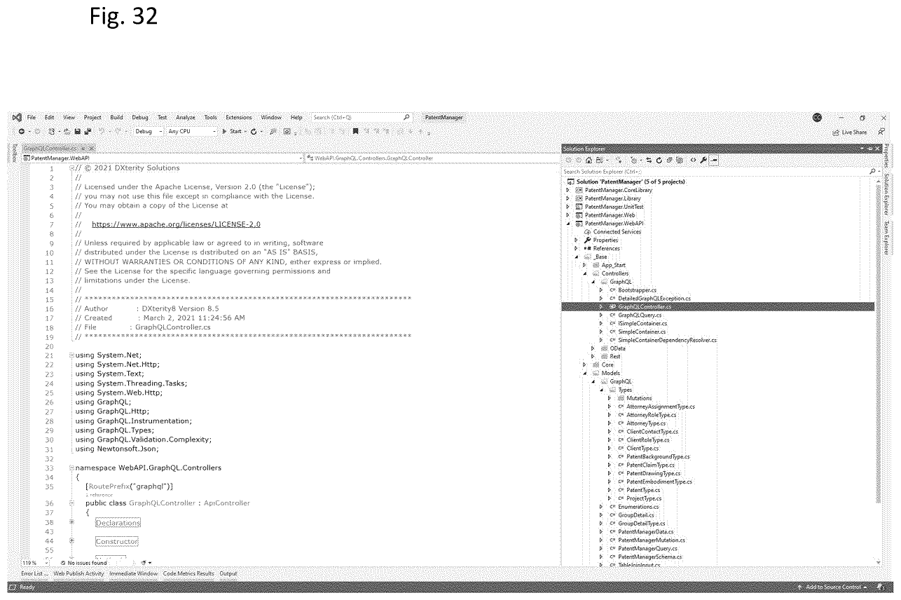

FIG. 32 is an example view of the generated code stack showing that GraphQL API code is stored as part of the base code.

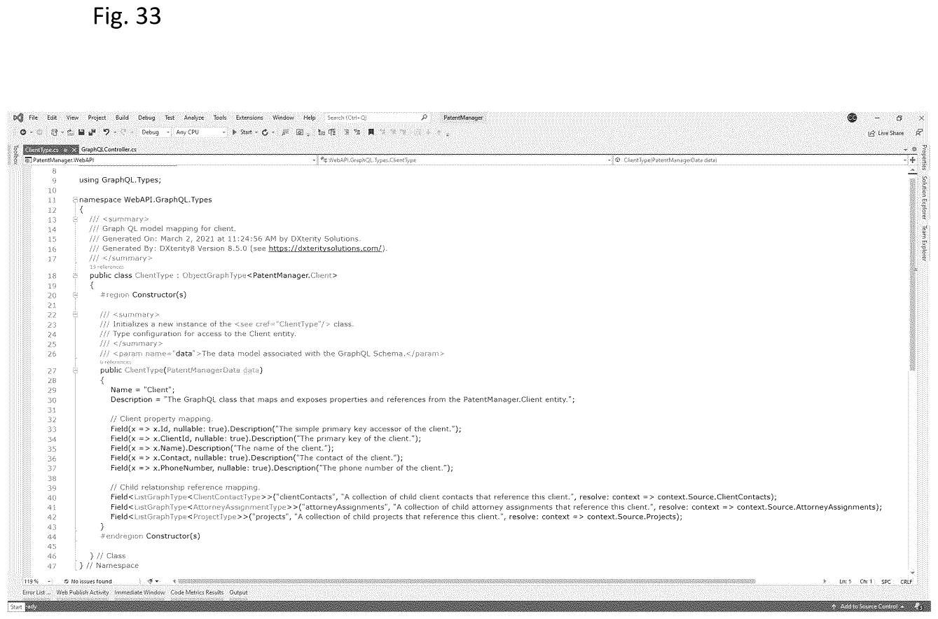

FIG. 33 is a more particular example of the generated code for the GraphQL API, illustrating for example the API properties mapped to the Client entity, including a Name, Contact, and Phone number properties and each of their related documentation descriptions. Note that the generated code is fully hydrated, such as that the fields, object classes and relations have been instantiated and thus populated and filled with domain data. In one example for the patent application, a fully hydrated “client” entity would include relations to all Contact types, attorney assignment and projects. subjects that he teaches, as well as all relations to all students currently taking classes in those subjects.

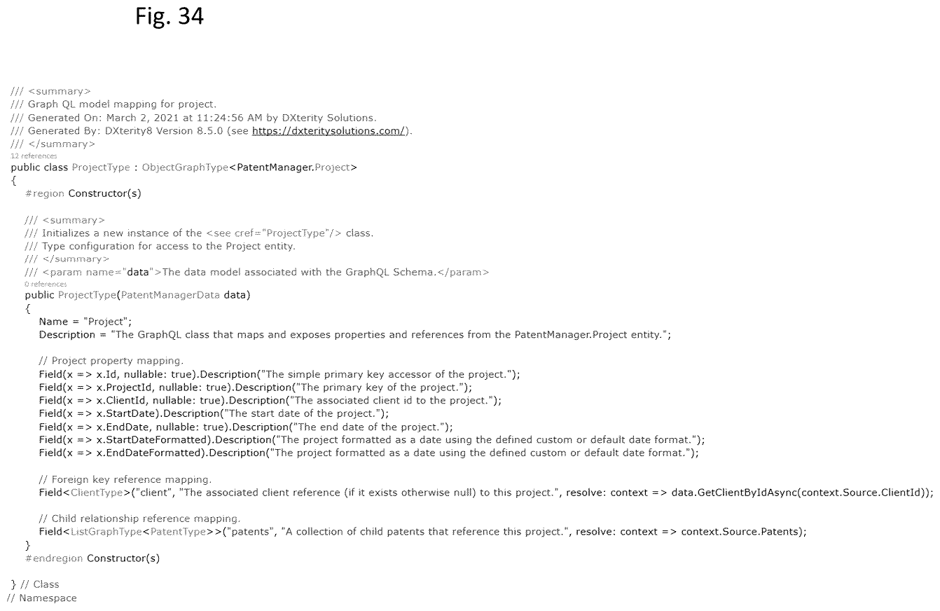

FIG. 34 is an example of a GraphQL API mapping the properties of the Project entity for the patent application.

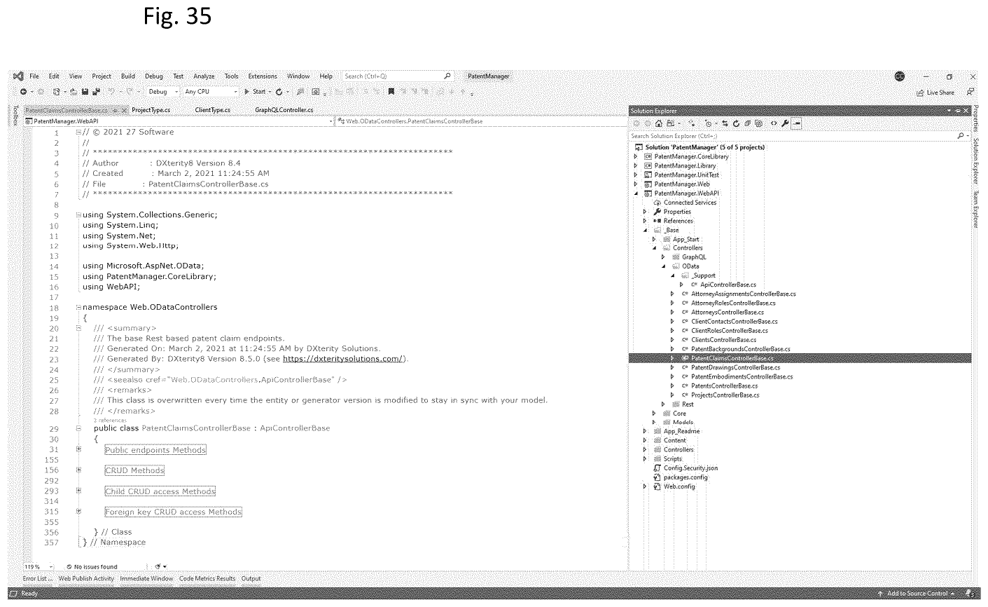

FIG. 35 is an example OData compliant API that may be generated for the “PatentClaim” entity in the other example application for a law firm.

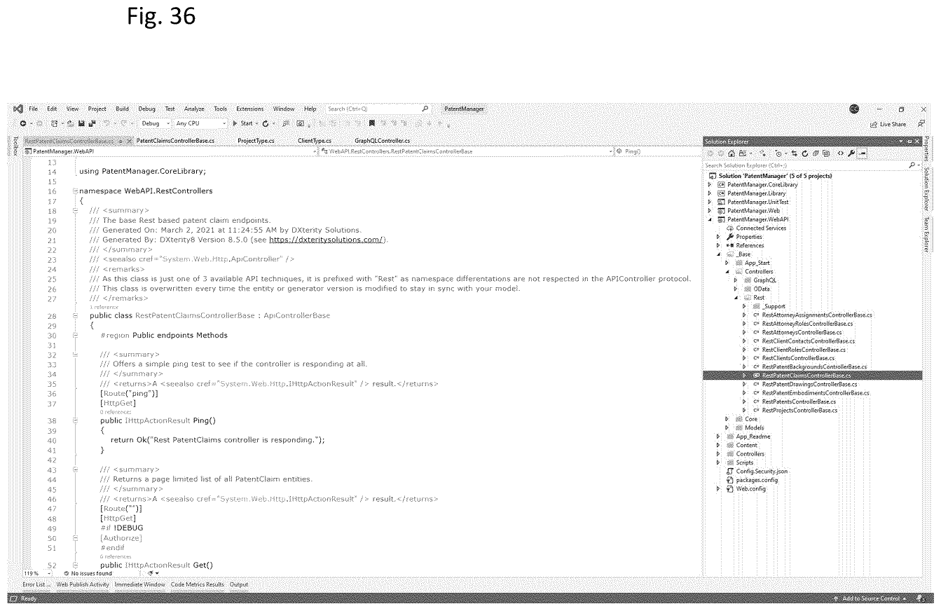

FIG. 36 is an example of a fully hydrated “PatentClaim” entity.

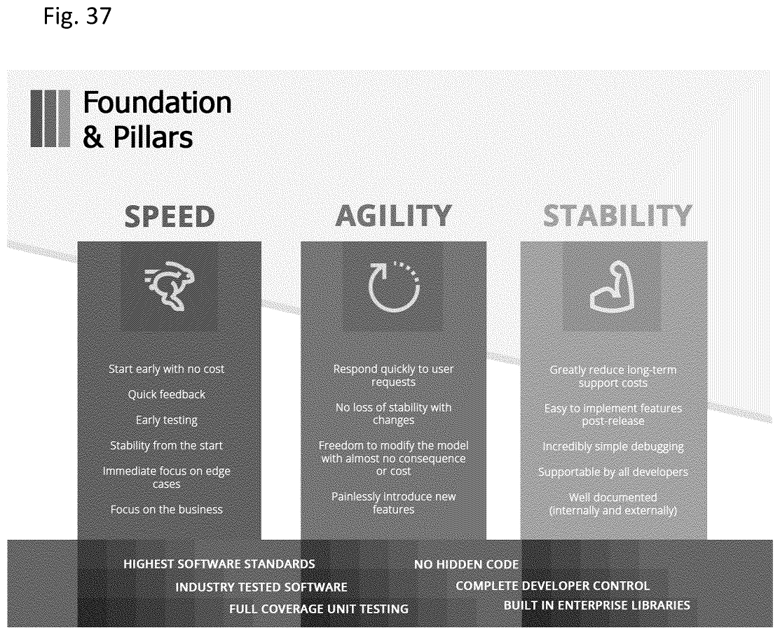

FIG. 37 is a graphic listing some of the resulting advantages of the code generation approaches described herein. These include speed, agility, and stability in the code generation process. The architect is able to start earlier with minimal cost and receives feedback more quickly. The solution may implement testing at the first juncture. Requests to modify the generated code may be quickly responded to, with minimal loss of results and maximized stability even with such changes. The process also reduces long-term support costs and simplifies debugging efforts, while guaranteeing well documented code. Operating budgets may be repurposed while simultaneously delivering maximum effectiveness over the life cycle of the software solution.

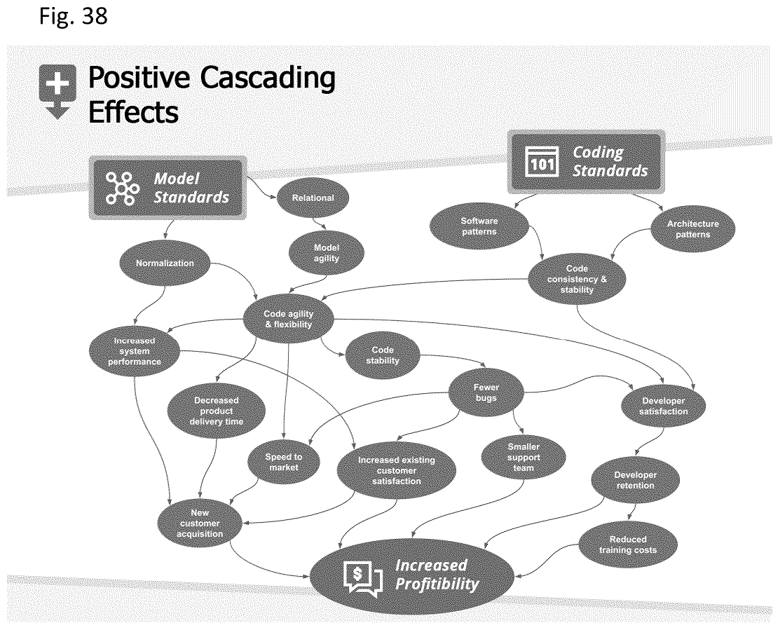

FIG. 38 is another list of some of the cascading effects of this approach. These include adherence to modeling standards that are desirable for enterprise class database application. Other standards such as coding standards, including application software patterns, architecture patterns, code consistency and stability may be enforced. Other cascading effects include increased system performance, agility, flexibility, and stability. A smaller team may support the application, with increased speed to market and improved customer and developer satisfaction.

III. Automated Authoring of Software Solutions from a Data Model with Related Patterns

### System Overview

As explained above, the present invention relates to a system and methods that may consume a data source and transform it into an abstract model. The abstract model may then be extended and then used to automatically generate into generated base code, Application Programming Interfaces (APIs), User Interfaces (UI), documentation, and other elements. Each of the generated base code, generated base APIs and generated base UIs may be extended. Extended elements are maintained in a framework, such as a different source code file, separately from generated based code elements. Of specific interest herein is that the generated code conforms to a variety of patterns.

An example implementation is now described and shown, starting with FIG. 1. Here a data source, such as data store 102, is made available to a code generation tool or platform 100 (also referred to herein as the DXterity platform). The data store 102 may, for example, be a database associated with a legacy software application. However, it should be understood that the source may not necessarily be a legacy application but some more recent application or even a new application under development. The data store 102 may be in any common form such as MySQL, SQL Server, DB2, Oracle, Access, Teradata, Azure, PostgreSQL or the like. The DXterity platform 100 is then used to generate an abstract model 104 from the input data store 102. The abstract model 104 is then fed to an author 106. The author 106 automatically consumes the model 104 to generate and regenerate code to match the model 104. The author may generate the code in certain forms, and also generate other artifacts related to the model 104. For example, the author 106 may generate or may use a core code library 122 and/or model library 124. But the author may also generate application base logic, a web application interface 126, a user interface 128, unit tests 130, and/or documentation 132 from the abstract model. The input source may describe the data in a database in other ways, such as via an entity relationship diagram, as explained in more detail below.

The abstract model is generated in a particular way to help ensure that the resulting code 122, 124 conforms to expected criteria. For example, DXterity 100 may be configured to ensure that the resulting generated code and artifacts 122-132 provide an extensible, enterprise-class software solution with late binding on UI and API elements. As now understood from the discussion below, this is accomplished by ensuring that the abstract model itself conforms to certain metrics or conventions prior to code generation. Enterprise class software is computer software used to satisfy the needs of an organization rather than individual users. Enterprise software forms integral part of a computer-based information system that serves an organization; a collection of such software is called an enterprise system. These enterprise systems handle a chunk of data processing operations in an organization with the aim of enhancing the business and management reporting tasks. The systems must typically process information at a relatively high speed and can be deployed across a variety of networks to many users. Enterprise class software typically has, implements or observes many of the following functions or attributes: security, efficiency, scalability, extendability, collaboration, avoidance of anti-patterns, utilization of software patterns, architected, designed, observes naming and coding and other standards, provides planning and documentation, unit testing, serialized internal communication, tiered infrastructure, exception management, source code and version control, and includes interfaces for validation, messaging, communication, cryptography, localization, logging and auditing.

FIG. 2 illustrates an example implementation in a bit more detail than FIG. 1. Here there are two input data stores 102-1, 102-2, respectively associated with two legacy systems including an IBM mainframe 140-1 running a DB2 instance 141-1 and an SAP/ERP application accessing an Oracle database 141-2.

The DXterity platform 100 consists of an analyzer component 200 and a schema modelling component 212. The schema modelling component 212 generates abstract models of the legacy databases 141-1, 141-2.

The analyzer component 200 analyzes the abstract models of the legacy databases 141-1, 142-2 against selected metrics, generates a score, and recommends resolutions to improve the scores.

A standardized database schema is then output from DXterity 100 as a meta model 214. The meta model 214 may then be re-platformed in various ways. For example, it may be migrated to an on-premise modern database 220. Or the meta model may be migrated to a cloud provider 222 or as a cloud service 224.

Artifacts generated by DXterity 100 may also be fed to other related functions, including an application development platform 230 that drives DevOps pipelines 232, or integration/orchestration environments 234 that support specific application development platforms 236.

Also, of interest is that the DXterity platform 100 may be used to generate its result as data-as-code (e.g., as .NET, or Java), data-to-container (e.g., as a Docker file), or data-as-API (REST, OData, GraphQL, etc.).

Characteristics of the Code Authored from the Abstract Model

FIG. 3 is one example of a hierarchical list of the functions, structures and concepts that may be performed or authored by the DXterity platform 100. An abstracting function 302 takes the physical model and generates an abstract model.

From the abstract model, then systematic authoring/re-authoring functions 310 may proceed. Systematic authoring 310 consists of automatically generating the extensible enterprise framework as executable code 350 as well as creating the related documentation 320.

Other functions or operations such as scripting a data source or extending 315 and decorating 316 may also be performed on the abstract model.

The generated extensible framework 350 architects the authored (generated) code in a particular way. More specifically, the code generated may be arranged into a core library 362, model library 363, API access 364, web UI 365 and unit test 366 elements.

In an example implementation, the core library 362 may further include code grouped as assistant functions 372 (including configuration parameters, reflectors, search, text manipulation, and XML), interface definitions 271, base classes 373 (including messaging support, entity support, data retrieval support, or core enumerations), exception definitions 374 (including audit, cache, custom, data, login, logic, API, and user interface, as well as schema definitions 375.

The model library 363 may involve generating context patterns 382 (including localization, messaging, logging, exception management, authoring, validations, cryptography, communication and caching), base code 383, and extended structures 384.

API access 364 may be generated in any of several API formats including OData 392, GraphQL 394, or REST 396 each of which may be accordingly hydrated, secure and documented.

The generated web UI 365 artifacts are also driven 398 from the abstract model in which case generic list and generic details are provided; or they may be extensible 399 (including overrides, configurations, authorization and authentication support with application settings 399 and/or model configurations and/or visualizations 391.

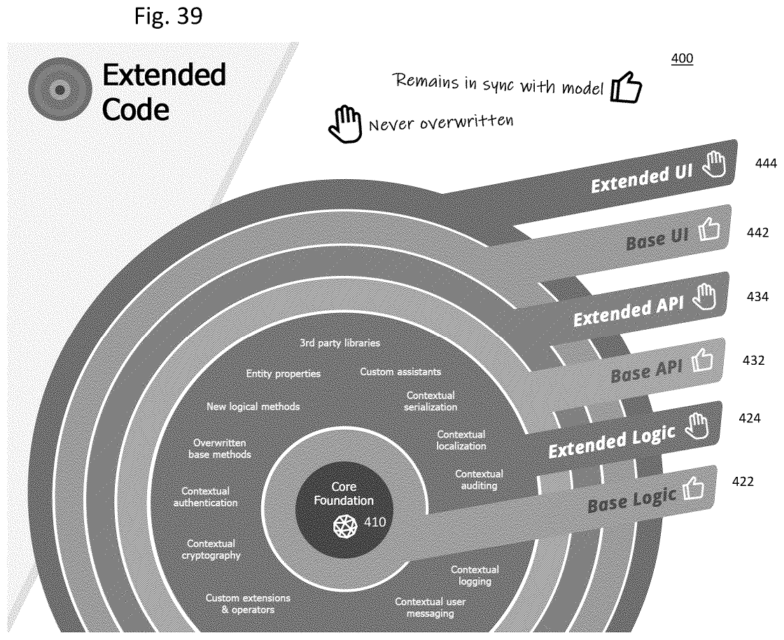

FIG. 39 illustrates the hierarchy of the generated code and of the extended code. More particularly, the generated code is divided into a core code foundation 410 and application specific logic including base logic 422, which is segregated from the extended application logic 424. API code is also arranged as generated base API code 432 and extended API code 434. Web UI code similarly includes generated base UI code 442 and extended UI code 444. The different code elements including base application logic 422 and extended application logic 424 are stored separately from one another, such as in different files. Similarly, base 432 and extended 434 API code are stored separately from one another, as are Web UI base 442 and extended 444 elements.

As mentioned previously, the core code 410 consists of elements that are used by more than one application or solution. For example, the core code may include common libraries and similar functions.

The base components specific to the application such as base logic 422, base API 432 and base UI 442 are automatically generated from the abstract model and always remain in sync with the model. Therefore, even though the developer is permitted to view and even edit the base application code 422, base API code 432 and Web UI base code 442, these base components are preferably rewritten whenever the developer requests code to be re-generated from the model.

The generated structures (or frameworks) may be used by the developer for placement of extended code including extended application code 424, extended API code 434 and extended Web UI code 444. These frameworks may thus be exposed to a developer for review (such as a data architect) and also made available for modification. These extended code elements, once modified, are not permitted to be overwritten by any subsequent automated regeneration of code. However, in some implementations, the extended code elements may be overwritten before any developer modifications are made to them. In some implementations, extended UI code may be stored in a configuration file to, for example, enable late binding as explained elsewhere.

As also shown in FIG. 39, patterns implemented by the extended code components may include a variety of methods and properties supplied by the developer. As the figure suggests, these may include overwritten base methods or entity properties, third party libraries, new logical methods, contextual serialization or context localization, contextual cryptography authentication, contextual user messaging, logging, auditing, custom extensions or operators. Again, these may be stored as part of the extended logic 424 or other components such as extended API 434 or extended Web UI 444.

Separation of Generated Code from Extended Code

As may now be appreciated from FIG. 39, the resulting code artifacts are layered or tiered. A lower tier provides a core foundation that is shared. Wrapping the core foundation is a base logic tier specific to the application. As with the core foundation, the base logic stays in sync with the abstract model every time code is generated or authored from the model.

The base logic tier is next wrapped by an extended logic tier. There may be numerous things a developer may do to extend the application logic.

Wrapped around that in turn is a base Application Programming Interface (API) tier which then in turn is wrapped by an extended API tier.

Next, a base User Interface (UI) tier may be wrapped by an extended UI tier. It is preferred to arrange code with the UI on the outside of the hierarchy because that code is what the end user observes as the application's behavior.

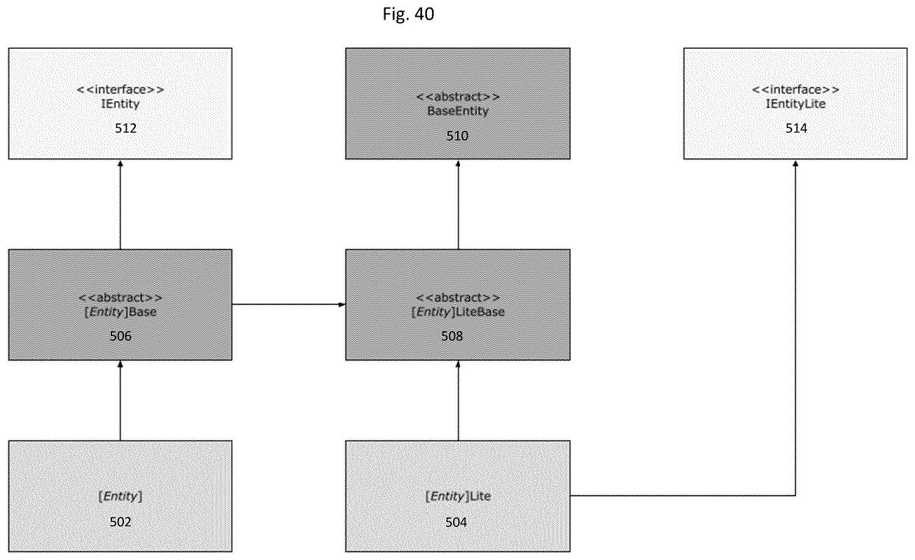

FIG. 40 is a class diagram visualization of the resulting code patterns illustrating how base code and extended code are split and separately controlled. The extended [entity] classes 502, 504 are what the developer may actually or should actually modify. Base code elements 506, 508, 510—although perhaps viewable by the developer—always stays in sync with the model. And the remaining classes 512, 514 are actually interfaces as provided by the DXterity tool.

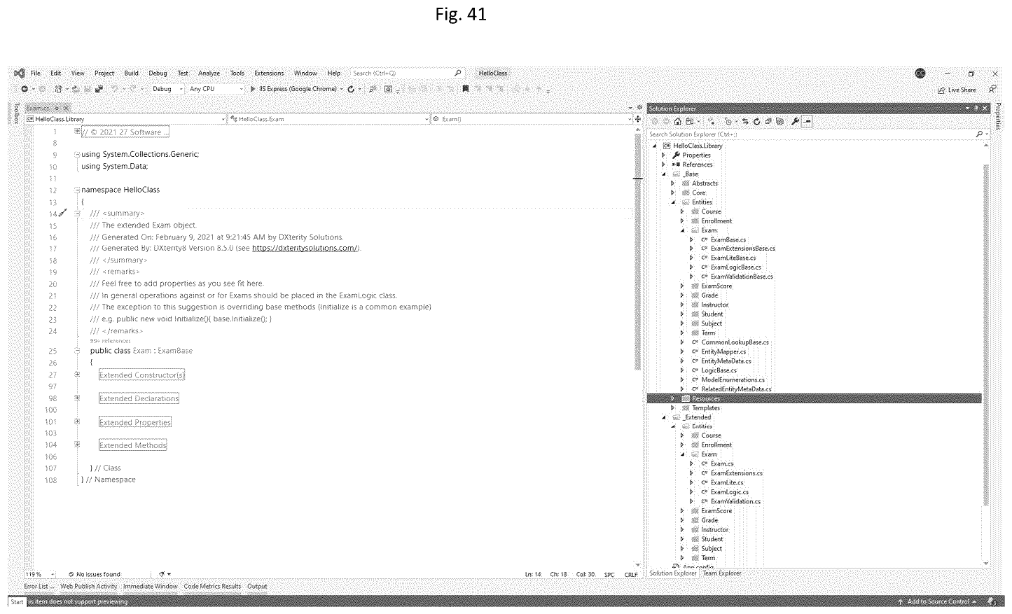

FIG. 41 is an example of the code generated for a particular application. The application may be used by a university to track entities such as courses, student enrollments, instructors, exams, exam scores, grades, students, subjects, terms, and the like. The resulting code may be viewed and/or edited by a developer using a tool that allows them view the generated solution (referred to as the solution explorer herein).

Using the solution explorer, the developer may see that generated code has been separated into different elements or project folders, including folders for a core library, a folder for base code, and a folder for extended code.

For each of the entities, separate files, folders (or other structures) are provided within the base code and extended code structure. Separate files, folders (or other structures are also provided for properties, references, resources, templates and other elements. As explained above, the base elements stay in sync with the model. So, for instance if the model is changed to add a column to the instructor table, then the base code for the instructor class will typically be changed.

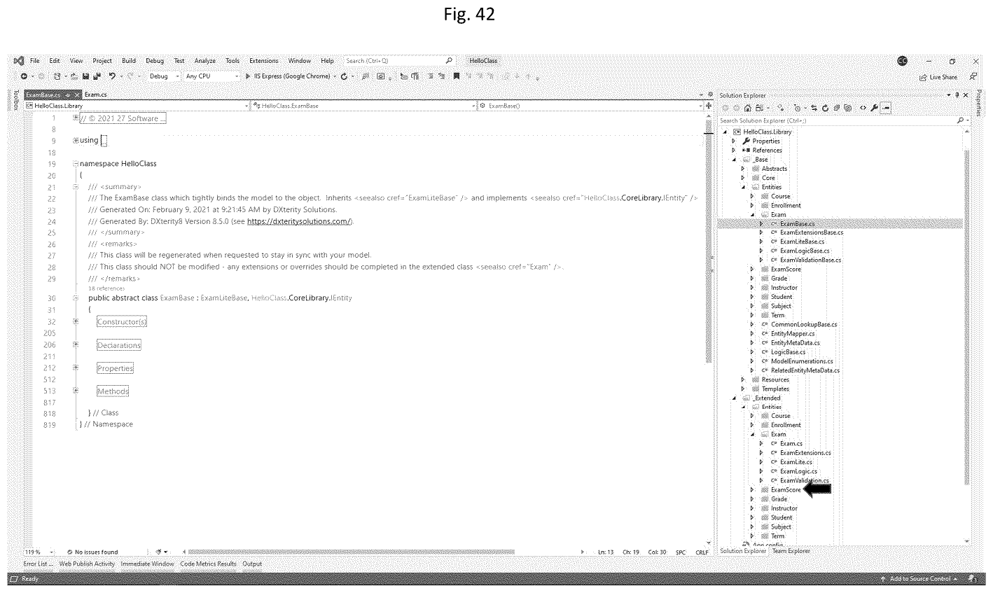

The developer is permitted to review all parts of the generated code for a class. As shown in FIG. 42, the developer may see when the base code for the ExamBase class was generated, and drill down to view the details of its code elements such as its constructors, declarations, properties, and methods. The DXterity platform may display a warning in this view of the base code that the class will be regenerated and that this code should not be modified.

The generated folders also provide a structure for the developer to place their extensions and modifications. Should the developer wish to have an extended property for the ExamScore class, then as shown in FIG. 42, the developer would navigate to the corresponding extended code section as indicated by the pointer. An extended method for that class may also be placed in the same folder.

These sections may typically be blank or empty when the framework is initially generated. The generated structure also informs the developer as to the inheritance properties. For example, if the developer navigates to ExamBase she may see that inherits ExamLiteBase. And if she navigates to ExamLiteBase she may view that code and see that inherits EntityBase.

The developer may view the structure, see what each of the components of the class contain, and that they are in sync with the model. The developer may also determine where to write and store extended code or unit test code, and remain confident that such extensions and unit tests are preferably not overwritten each time the base code is re-generated.

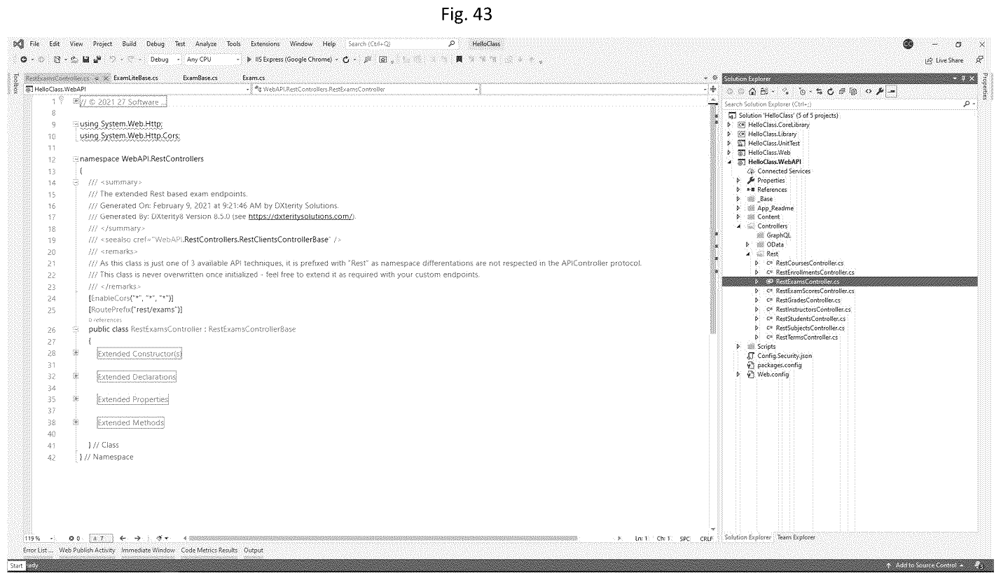

The same is true for generated API code. See FIG. 43 as an example. If the developer wants to create extensions to implement a GraphQL, OData or REST they navigate to this screen. Here the developer is in the process of extending a REST API for the exam class. The generated structure for the constructors, declarations, properties, and methods, although initially blank, provide a well-defined location for the developer to place any extended code and its attributes. Note that the generated “dummy” extended code may include comments that inform the developer that they are free to extend these code sections and that they are preferably not overwritten once initialized.

Enforcing a structure or framework for generated and extended code in this way (for logic, APIs and UIs) is valuable. It enables developers to stay focused on what is important to their particular end uses, without being distracted by base code logic.

In addition, the code generated from the model may in most cases be operated immediately after generation. In the university example, the university's administrative staff may immediately enter, access, and/or update data for the student enrollments associated with a particular semester course.

### Context Patterns

The code generation processes implemented by the DXterity platform 100 may also implement what are called context patterns.

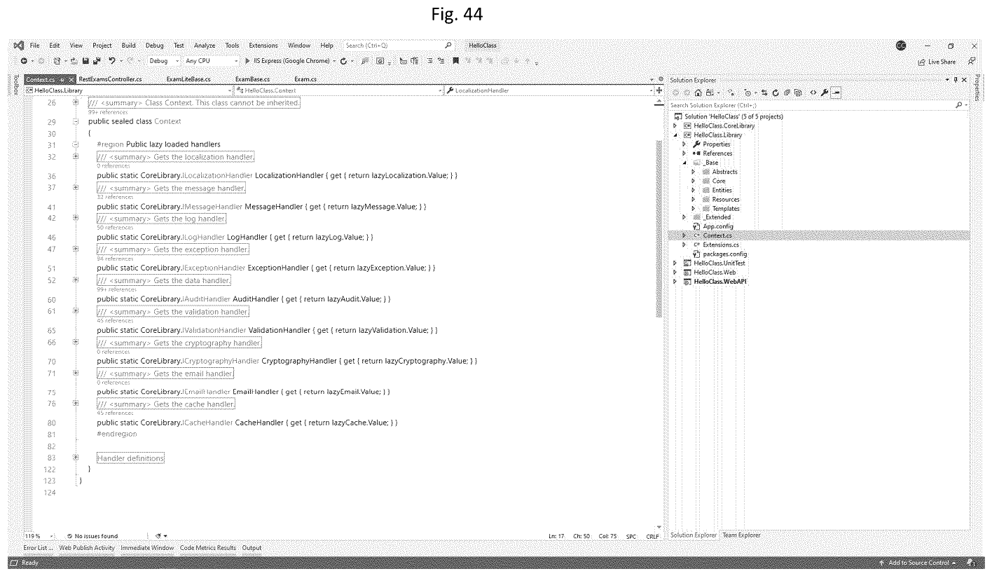

FIG. 44 is an example of a public class that is created by the code generation process called context. The context class serves to store or manage a number of lazy loaded handlers for different features considered to be contextual, in the sense that they may wrap or envelope the entire application.

One example context is localization. Localization is referring to features such as a time format or currency format or date format specific to a physical region or place where the application is hosted.

The next thing is a message handler. This context entity may be used to enforce language specific behavior. In one example, the application may be hosted in a bi-lingual country such as Canada that may require both French and English versions of an API or UI. The language context may thus be used as a single place to hold common messages that may be propagated throughout the application.

A logging handler may be used for storing global attributes for how a class is to log events. It may specify how, where, when, and what to capture in a log as well to what degree an event should be logged

An exception handler specifies how to manage exceptions across tiers. For instance, a developer may want to raise an exception in a tier that occurs in the UI layer.

The audit handler may serve to manage how data changes. This aspect of the context class may be used to implement auditing of reads, writes, and edits to the database, and specify which classes or objects the developer wants to audit, when, and how often. For example, an object that represents new tuition payment entries may need to be audited every Thursday at noon, but continuously monitored for any changes.

The validation handler may be used to validate attributes of selected objects, such as their format, and for other purposes.

A cryptography handler may implement different rules for encrypting data. In the university example, say, the instructor class may remain unencrypted, but a personal identifier column in a student class may need to be encrypted. Entities in an application that support a bank may have different encryption requirements than an application that supports a social media platform.

The handler, or more generally, a communication handler, may also implement criteria specific to these functions. For example, an email handler may specify using an SMTP protocol and API.

A cache handler may specify whether caching is available for data, mechanisms for how it is to be used, how often the application should refresh the cache, and so on.

As can be appreciated, these attributes of the application considered contextual may thus be implemented in a centralized context pattern.

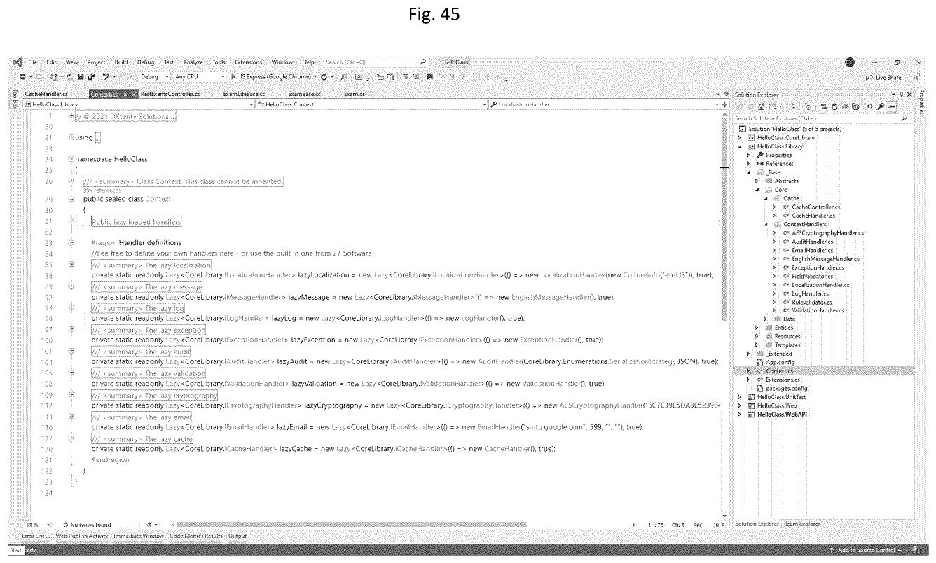

Contexts may also be considered private and specifically include developer generated code. In other words, “public” or “default” contexts may be overwritten- and the generated code then may provide the developer with a defined location to place such developer-provided extensions. See FIG. 45.

For example, it may be desirable for the cryptography handler to be customizable. Perhaps the DXterity platform is configured to generate code that implements AES cryptography via the public cryptography handle. However, in one example use case, the developer determines that a selected class needs to be protected with an alternate secure method such as triple DES. That change may be specified in a private static handler that the developer writes and stores separately from the public, global handler.

Similarly, a different authentication method may be desirable for an email handler. Rather than modify a public communication handler that uses SPF, the developer prefers DMARC authentication method in the private handler pattern. DXterity centralizes where all of the attributes are enforced. In this example, the email handler may be modified in one central location, instead of the developer having to make separate modifications in each and every place in the code related to the content for emails to be sent (such as warnings, updates, communications to clients, etc.).

### Response and Action Patterns

Responses and actions may also be implemented according to defined patterns. This approach avoids a problem where the code that controls responses and actions with and between tiers may otherwise become fragmented.

In an example where a user of a typical enterprise application and data source might be asking the application “How many widgets did we sell last month?” Referring to FIG. 39, such a query might generate database command messages that include an “action” (such as “get data”) that travels or “bubbles down” from a custom UI tier (which defines the visual that the user sees) to say five or more tiers before it arrives at the application logic tier to be processed. The response then bubbles all the way back up through those same tiers to the extended UI tier which finally displays the answer to the user. In any of those tiers the action-response pattern could encounter an error that involves rich data or some other problem.

In a typical enterprise application, there is no standard defined within the application logic in the model (nor across different applications) of how communication should be serialized and transferred between tiers—or worse, there may exist multiple unique methodologies all within the same solution. It is common for problems to occur within a specific tier. For example, when a method needs to call another method which results in calls toother methods that summarize the requested data.

Defined patterns to manage messaging between and within tiers is therefore desirable.

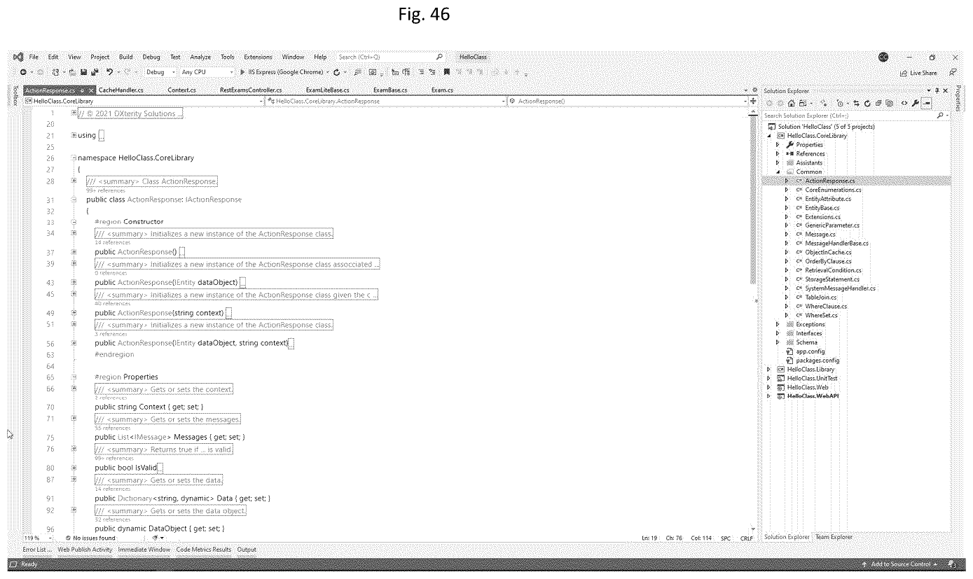

FIG. 46 is an example of how to apply an action-response pattern to a constructor. The generated code may include a blank action-response pattern, providing the developer a place to set the properties.

As examples, action-responses may be created within the context of an entity where a user object needs to be updated or for bulk inserts or when a data object is created and initialized. The developer may create the action-response within the context for those specific entities.

A key part of the action-response is that it provides a collection of related messages. Thus, the action-response pattern may be a rich object in the sense that it specifies positive, negative, warning, and neutral responses.

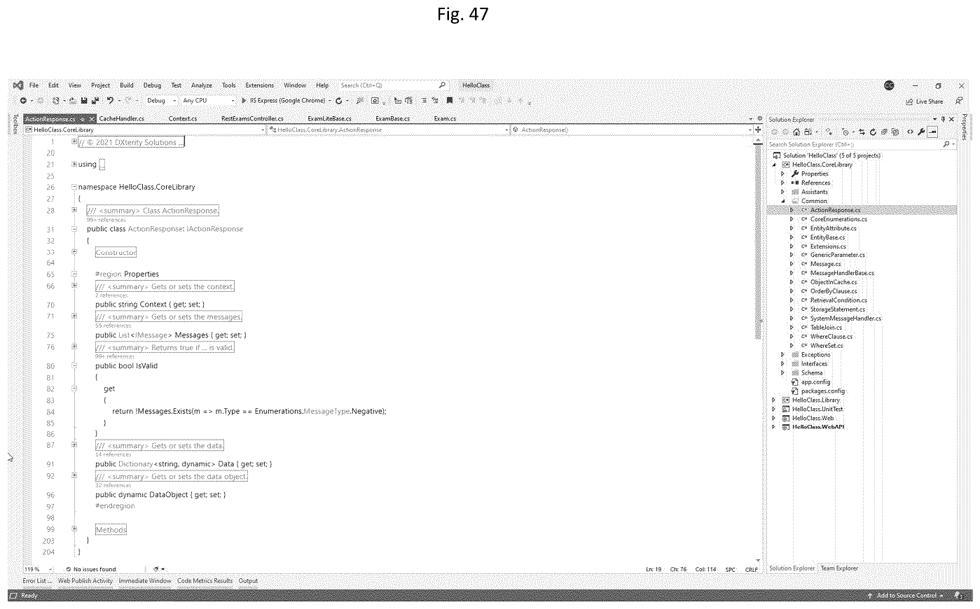

FIG. 47 shows examples of valid and negative responses to a get property action. Note this example is specific to a C-sharp implementation, but it be understood that an equivalent set of valid and negative responses in other languages are possible, such as a Java method accessor.

Of course, the developer may also define their own additional response types within the same pattern as needed. There might be a couple of different warnings, and three positive responses. These response types may be extended as the solution requires. A common extension is to add an “information” class.

Therefore, action-response patterns may be used to handle warnings in an orderly fashion. In the case where an action is to persist a fully hydrated object, that action may in turn call ten (10) tiered methods. Responses are bubbled up through the messaging between tiers until they reach the uppermost tier; a UI tier for example. If only positive and no negative responses are received, then the UI tier may report the same. By providing a standard way to handle action-response patterns across a solution, they become far easier to manage.

The DXterity platform may use data dictionaries to support the ability to collect messages as they bubble up through the tiers. A dictionary may be a collection of named dynamic objects, a data structure or other similar technique. The dictionary may be, for example, a collection of strings (“positive” or “negative” responses), or a single integer (such as when the query is “How many widgets did we sell last month?”). The dictionary could be a rich object such as a list of 5 integer objects (When the query was “What were Susan Jones' grades this past semester?”; or it could even be a detailed report in the form of an XML file (e.g., the response to “What is the Chemistry Department's emergency procedure in case of a fire?”).

This type of data object may be used to support appending a series of responses to actions as they “bubble up” through the tiers. Generally speaking, each method at each tier may have its own response. But it may handle such a response by adding it to a response that it received from another.

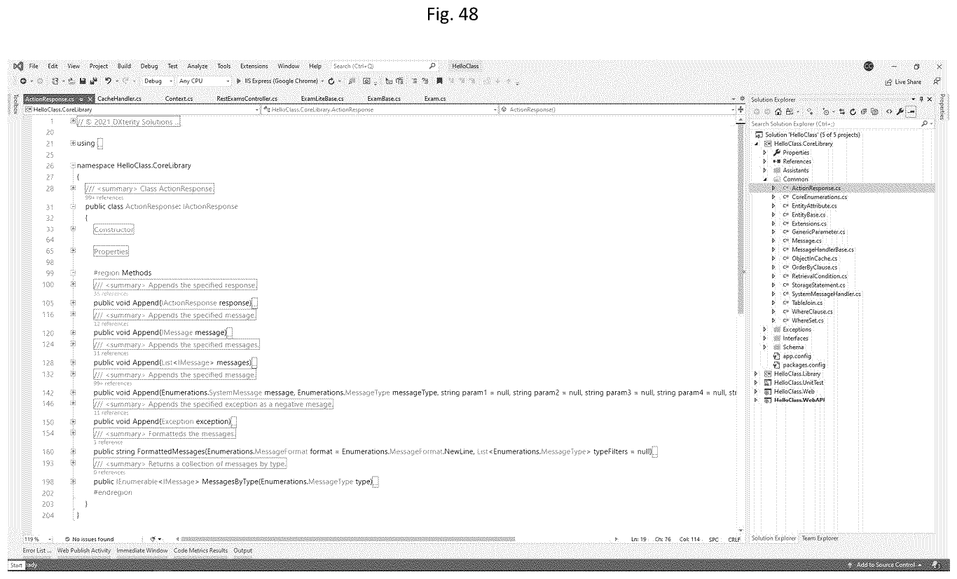

FIG. 48 is an example of an append method. A method may simply append its response to a message. Or it may append a collection of messages. It may append a very specific type of system message or it may append an exception.

Note too that a single “negative” response appended to a series of “positive” responses may cause the entire series to be treated as a negative response.

A tier may also specify a method to filter messages or format them. Such a method may, for example, filter messages by returning only the positive messages or only the negative messages. These types of methods may also return messages in a specific format (e.g., as an XML file with a new line character between each message).

These action-response patterns provide an orderly way to process messages among and between tiers from the base code all the way up through the UI tiers.

### Code Authoring

The generated code may be interface driven in the sense that the database may be treated as an interface; languages may be treated interfaces; projects may be created as interfaces; operating systems may be treated as interfaces and the code author may be an interface.

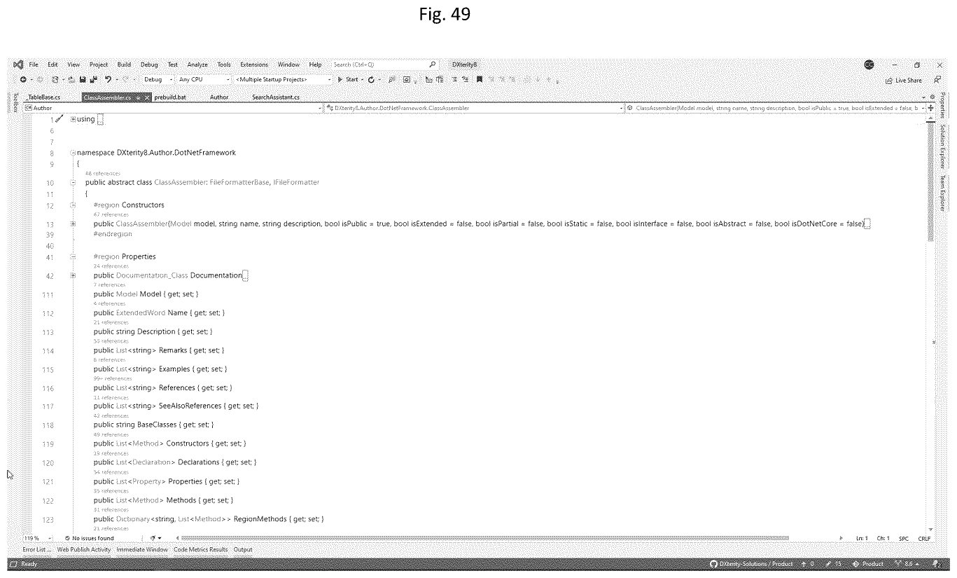

As FIG. 49 shows, the generated artifacts are organized by language (e.g., here the language ultimately generated may be a .Net framework) and then by project. In this case the code relates to a library project. Notice that the paths match exactly the paths to where the output is generated. As explained above, when the library project is generated it has core code, base code and extended code. Under extended code, in turn, there are entities, resources and templates (as an example).

Looking further into the organization of the generated code, the developer may see that a class includes a constructor folder, properties folder, methods folder, references folder and declarations folder. It can thus be appreciated that what looks like a “folder” in the solution explorer actually ends up being generated by the author as a single class. That class in turn is a collection of other classes which are constructors, declarations, properties, methods, and references.

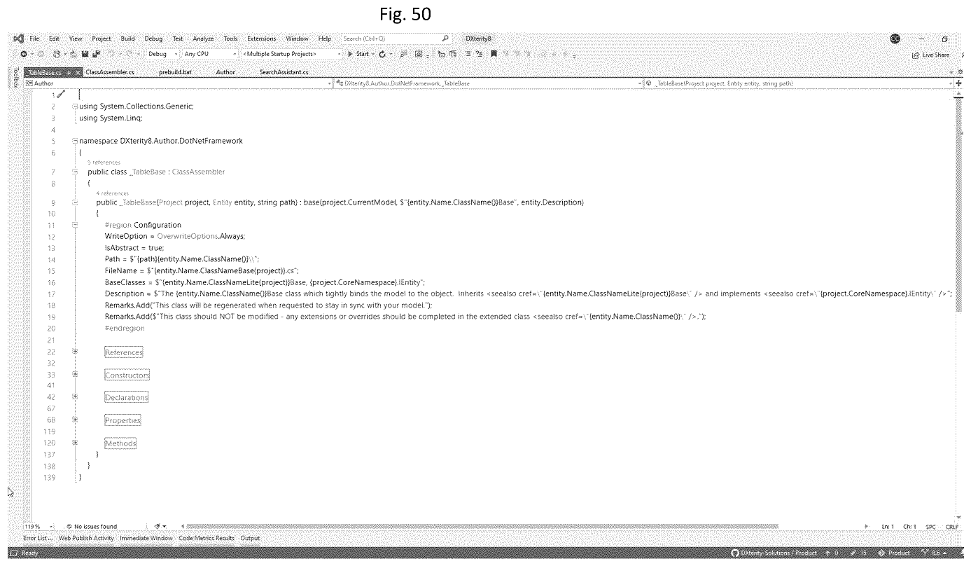

The author produces metadata at these levels. For instance, a constructor is a special type of method. In the example shown in FIG. 50, an example class may have six constructors, which follows a convention of being organized into tablebase constructors and then by identifier. Parameters and interfaces are also classes that have defined properties.

The author may not have to generate all of these metadata from scratch. The author may not have to define every constructor, every method, every property for every class. The author may use name space replacements or some other type of reference replacements called common resources. Each time code is compiled from the model, the common resources may be placed into a zip file (or other file archive).

In order to efficiently manage and maintain generated code as well as maximize code stability and eliminate code duplication, solution files may be authored by several techniques including in a line-by-line raw creation and in a resource file. Raw files are highly correlated to the model entity. Resources files may require minimal changes such as replacement of a variable or of a block of code.

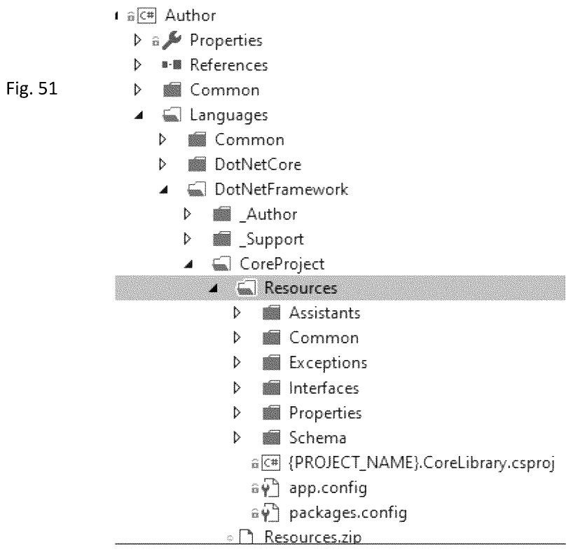

Resource files use a technique that was created to satisfy many operational constraints including the ability to simultaneously make global internal changes, make class specific changes, manage files based on output language, manage common files across multiple languages, edit files in an editor specific to class (config files, code files, html, etc.), change files names dynamically, manage files in relation to their final destination, integrate the reference files seamlessly into the solution/author and others. At the core to this technique may be the use of a Resource.zip file or other similar embedded resource files as well as the logical grouping of folders, as shown in FIG. 51.

Variable replacement by {NAMESPACE_CORE} and syntax highlighting as well as other code may allow all files to be edited in a similar way. When the author is compiled a pre-build hook may compress all the resource files and replaces the related embedded resources. Properly configured the resource.zip files may be part of the solution such that the compiled code may have full access. Of particular interest is that the embedded resource files may not be copied to the generated output folder. The author when processing resource files may process each zip file in turn by transversing those file folders and subfolders to verify existence, to create if needed and perform any replacements and extract the file to the proper path.

Because the author zips this entire folder, the path may be extracted for that resource file. More generally, the subfolder structure is exactly what is actually generated as compiled code—in other words, it's the location where these individual things get generated to.

A file name may also be generated through replacements.

As mentioned previously, code may be written locally or remotely, such as to the cloud.

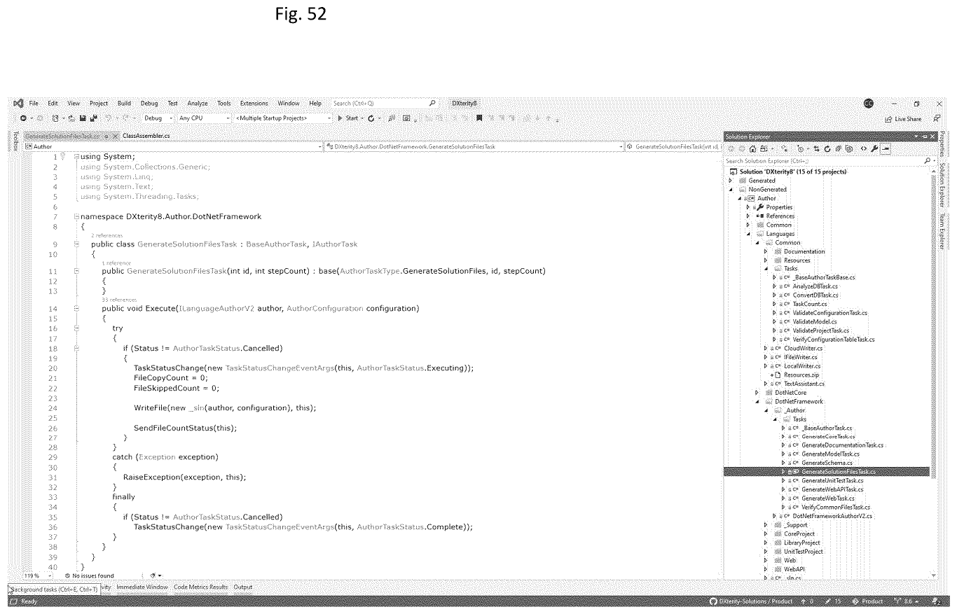

Furthermore, authored code may be further broken down into what are called tasks. FIG. 52 illustrates some examples. Example tasks include validating the model and validating the configuration.

Each language may have specific tasks that are organized by language, for example, such as a .Net framework or Java. An additional or alternative custom task, project or validation step may be easily inserted into this framework of generated codes.

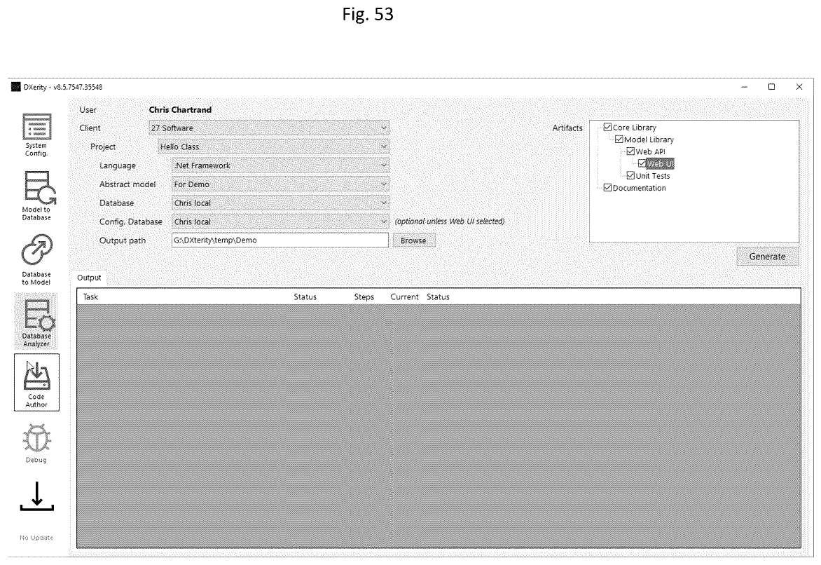

FIG. 53 is an example of a user interface for a developer to interact with the code author; in this case in the form of a Windows application. Applications for other operating systems may also be generated. The developer may select the customer, the project, the generated language, and interfaces. The choices may be selected from dropdown menus. In this case the developer is generating the “Hello class” project against the “For Demo” model for a .Net framework using the “Chris local” database.

The developer may also select artifacts to be generated or not generated such as a Core Library, Model Library, Web API, unit tests and documentation.

When the developer clicks on a generate tab, the DXterity platform starts creating tasks. At this stage the platform has completed validation of the configuration and validation of the project settings, but has not yet finished validating the model, verifying a configuration table and a list of other tasks. The list of other tasks, including generation tasks, may depend on the results of validation and configuration. In other words, the author may not initially know all of the tasks that it needs to perform until some of the initial configuration tasks are complete.

Tasks may be individually run as separate threads. If one task fails, the overall process stops. Additionally, the tasks may provide warnings to the developer.

As an example of the use of the interface, if after generating .Net code, the developer wishes to change to Java, then the same author interface is used to immediately generate the Java code or generate Java code in an alternate operating system. The author validates the configuration and the model in the same way for generating code in either language.

### User Interface Patterns

The DXterity platform also generates user interface contexts as patterns. As explained above, DXterity constructs an abstract model and generates output using that abstract model. The abstract model can be further consumed and converted to what is called a schema that relates to some aspect of a user interface. The schema is then made available to the application logic tiers (base and extended) as well as to the web UI tier.

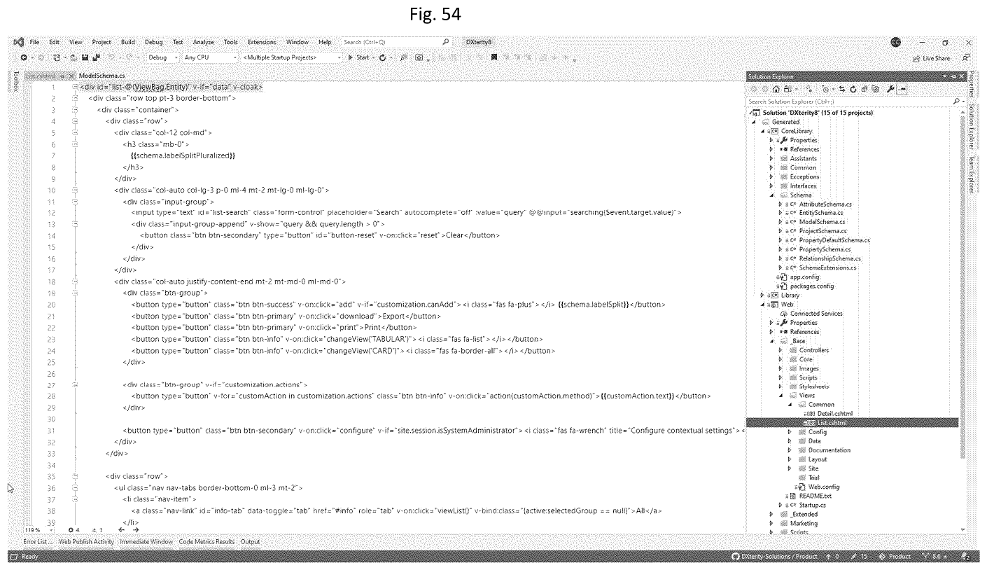

Initially the generated web UI solution does not have specific information about the views that are appropriate for specific entities or entity types. The traditional methodology for programming is to control or define a view for each entity. However, with the DXterity platform, the web UI components dynamically consume the schema. For example, when the generated code loads a page for an end user of the generated application, the page looks like it's a custom page. However, the page is actually generated by using the schema to control the rendering. FIG. 54 is an example of where the schema may be stored among the generated code. As a result, a single complicated page may be maintained instead of many different simpler pages, making management of revisions and maintenance much easier and efficient.

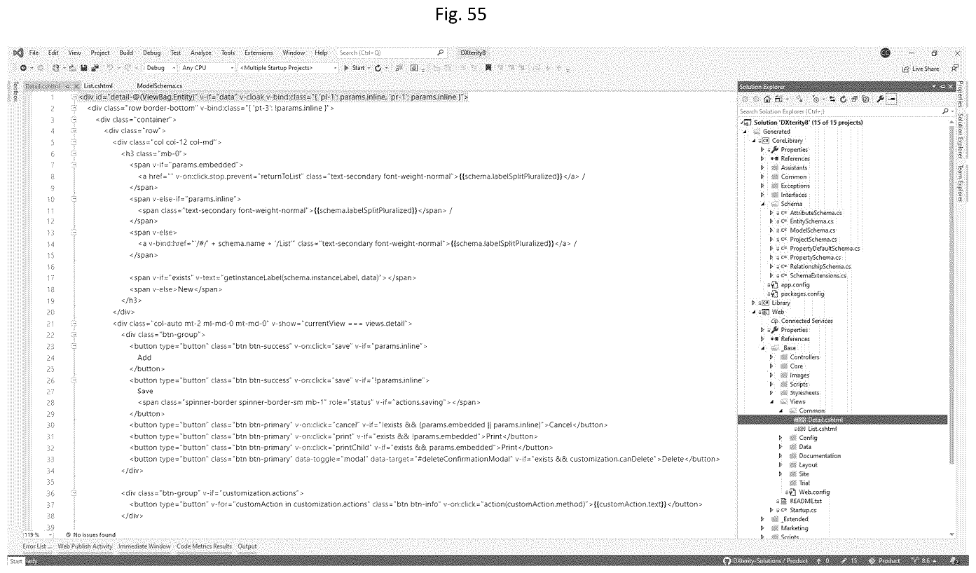

FIG. 55 illustrates an example schema for a list view. The schema may be invoked any time a list needs to be displayed in the UI. It may include the reporting elements, a card view, a list view, support searching, sorting, exporting, and other functions appropriate to a list. Labels and custom actions may be defined here as well.

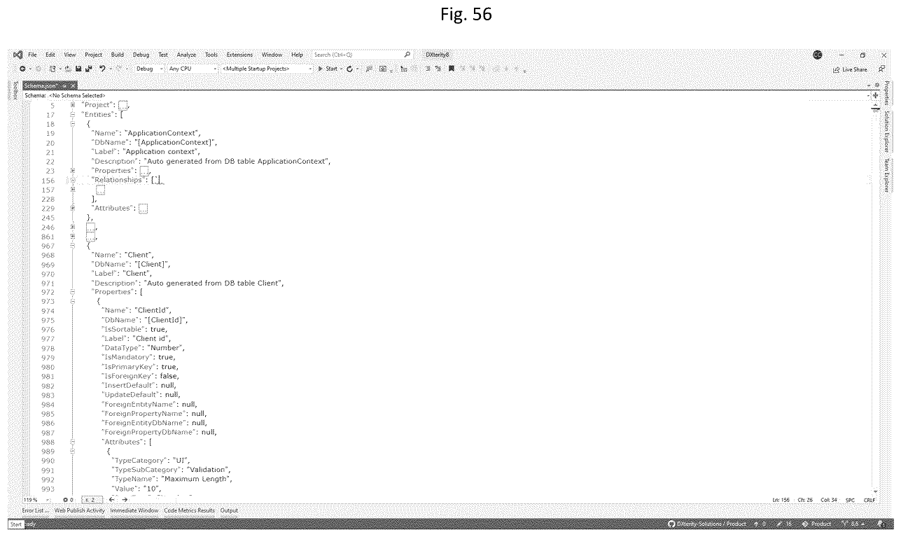

FIG. 56 is an example of a detailed schema. The details may be used to define another type of UI page that dynamically renders the page in groups based on whatever properties the object has. It may specify whether it should be visible, when should it be visible, how should it be grouped, what are defaults, how to print it, and so forth.

There may not be page specific views. Rather, the views may be driven by schema-meaning that the developer does not have to design and maintain each and every page separately.

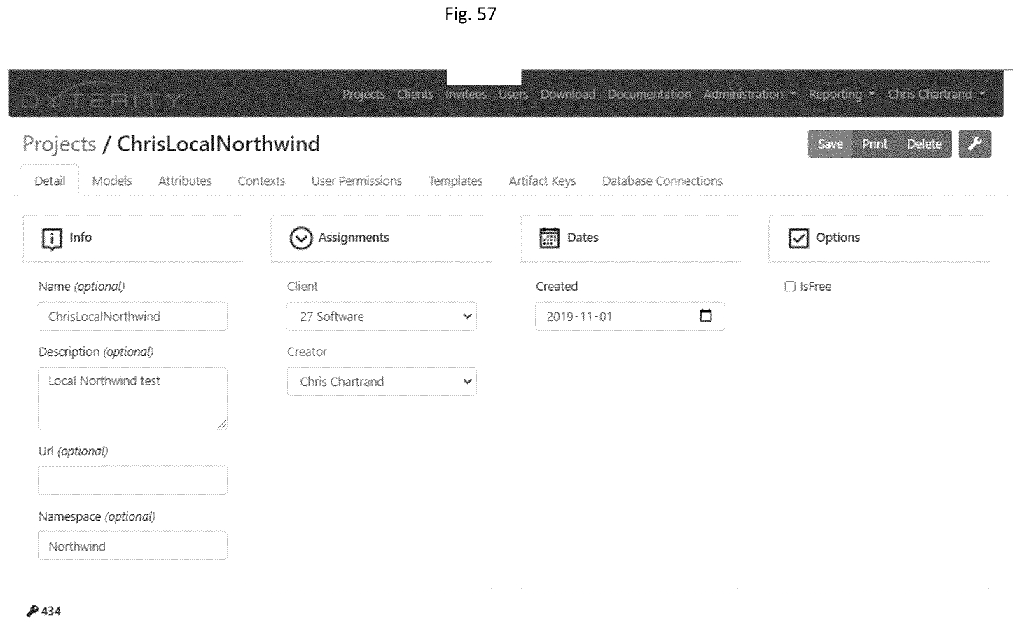

FIG. 57 is an example of how a developer may specify the schema for a web UI. The schema understands dates, checkboxes, and dropdowns so when a foreign key relationship is identified, the schema renders the UI page as the appropriate data type of the object. The schema knows what's mandatory and what's optional. It supports actions such as save, print, delete. Most importantly, because the UI is based off that schema it knows that these artifacts are all related to this object.

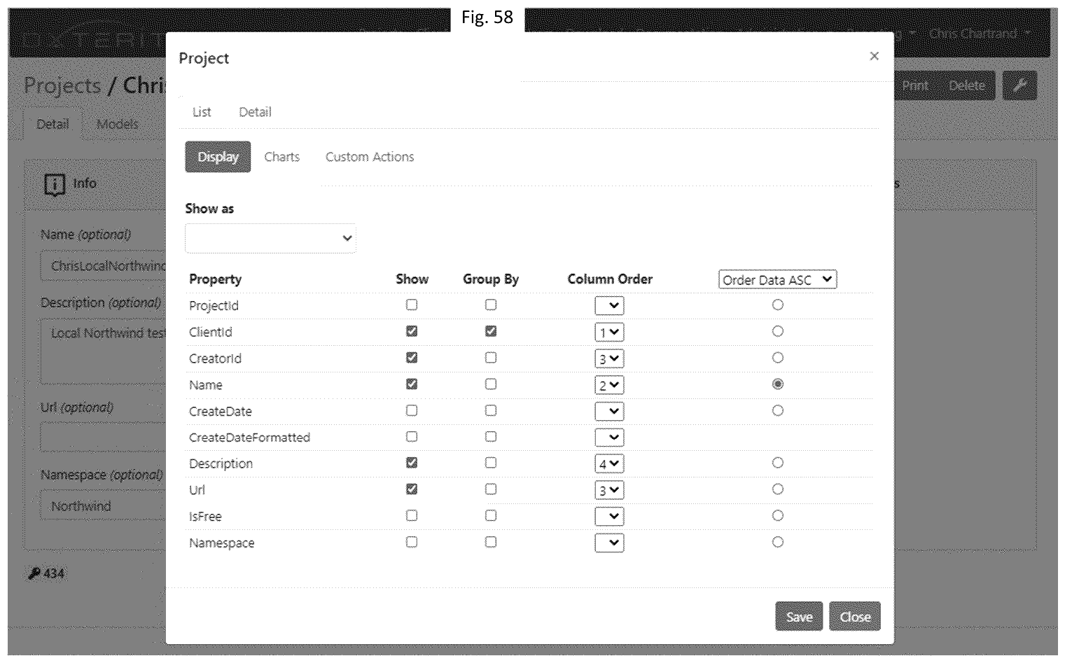

Note that these features are not generated via customized code, but rather through a UI and storing a configuration file. FIG. 58 is an example of how the developer may specify the display attributes for the classes associated with a project. A default view may be specified for each. Each class may be enabled or disabled for display, or grouping. A column order may be specified, and whether it is displayed in ascending or descending order.

The developer may specify that a particular JavaScript function is to be called when a certain button is clicked.

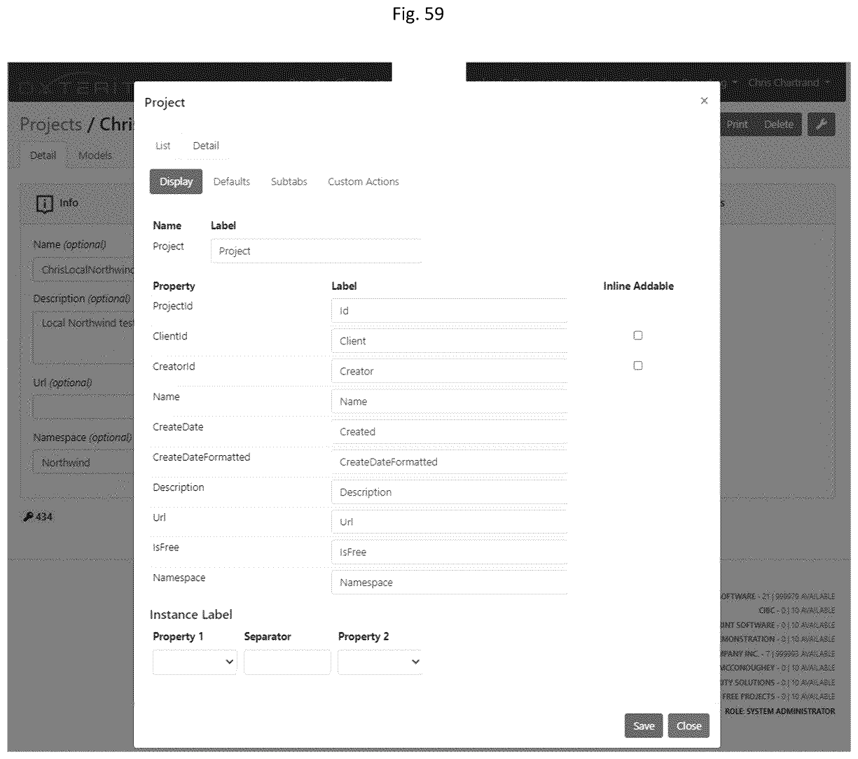

In another example, FIG. 59 shows a detailed action view. Here a class might be called “ClientID” as a database entity. However, the developer prefers that class to be displayed as just “Client”. So, the displayed name of a class may be changed here in the UI schema.

In another instance, the developer may want to add a child object that needs to be submitted at the same time as a group. That child object may also be configured using the schema.

The developer may also configure subtabs, and decide whether to show them or not and to reorder them.

It may therefore be appreciated that the DXterity platform may be used to rapidly generate code and an entire enterprise solution from a model. However, the generated code is structured to protect generated code from developer modifications while still fully supporting desired customizations.

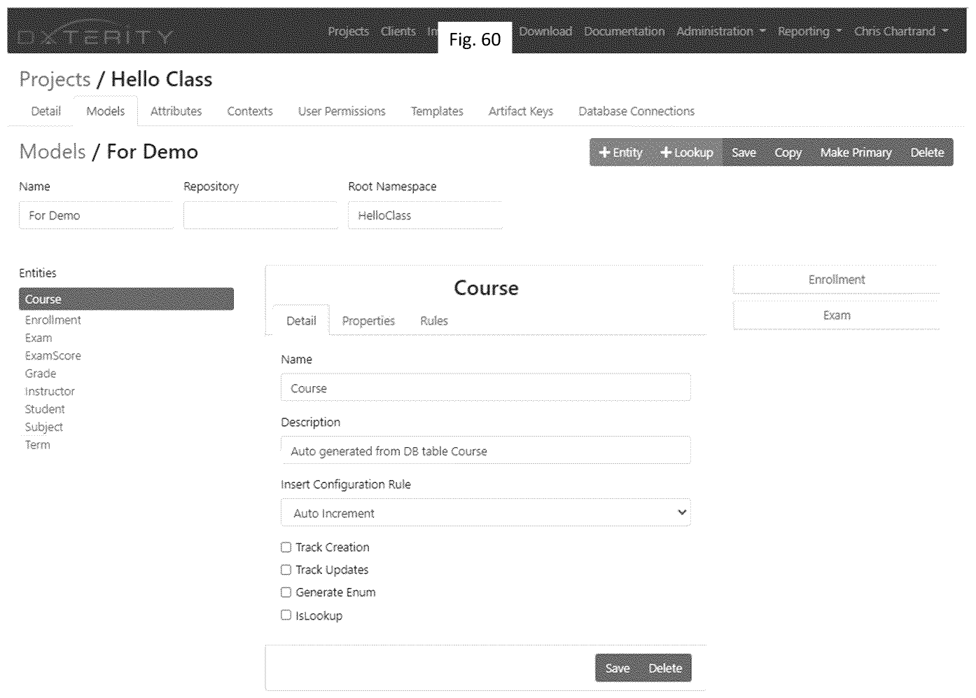

FIG. 60 is an example of an end user web interface that was generated by DXterity.

### Further Implementation Options

It should be understood that the example embodiments described above are not intended to be exhaustive or limited to the precise form disclosed, and thus may be implemented in many different ways. In some instances, the various “data processors” may each be implemented by a separate or shared physical or virtual or cloud-implemented general-purpose computer having or having access to a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments of the components may therefore typically be implemented in hardware, firmware, software or any combination thereof. In some implementations, the computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that may be rapidly provisioned and released with minimal management effort or service provider interaction. Such cloud computing deployments are relevant and typically preferred as they allow multiple users to access computing. By aggregating demand from multiple users in central locations, cloud computing environments may be built in data centers that use the best and newest technology, located in the sustainable and/or centralized locations and designed to achieve the greatest per-unit efficiency possible.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block, flow, network and code diagrams and listings may include more or fewer elements, be arranged differently, or be represented differently.

Other modifications and variations are possible in light of the above teachings. For example, while a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

Certain portions may be implemented as “logic” that performs one or more functions. This logic may include hardware, such as hardwired logic, an application-specific integrated circuit, a field programmable gate array, a microprocessor, software, wetware, or a combination of hardware and software. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Also, the term “user”, as used herein, is intended to be broadly interpreted to include, for example, a computer or data processing system or a human user of a computer or data processing system, unless otherwise stated.

Also, the term “developer” as used herein, is intended to refer to a particular type of user who is enabled to create software applications or systems that run on a computer or another device; analyze other users' needs and/or then design, develop, test, and/or maintain software to meet those needs; recommend upgrades for existing programs and systems; and/or design pieces of an application or system and plan how the pieces will work together.

The above description has particularly shown and described example embodiments. However, it will be understood by those skilled in the art that various changes in form and details may be made therein without departing from the legal scope of this patent as encompassed by the appended claims.

1. A method for generating code from a model of an application and a data store, comprising:
analyzing the model to determine two or more anomalies therein wherein the anomalies are data quality metrics selected from a group consisting of at least relational, normalization, or naming conventions;
determining a quality metric based on the two more anomalies; and
generating code from the model only when the quality metric is above a predetermined threshold, wherein the code is selected from scripted code solutions for resolving the anomalies discovered during the analyzing step.

2. The method of claim 1 wherein the two or more anomalies are selected from a group consisting of relational, normalization, column normalization, table convention, column convention, incongruence, duplication, pluralization, or imprecise data type description.

3. The method of claim 1 additionally comprising:
determining one or more resolutions that resolve the anomalies in the model; and
applying the one or more resolutions to the model.

4. The method of claim 3 additionally comprising:
locating all places in the model that exhibit each anomaly; and
generating scripts that are in a format specific to a database technology to apply the resolution to each such place.

5. The method of claim 3 wherein the resolutions include one or more of:
adding missing foreign key references;
adding missing foreign key tables;
adding missing primary key;
normalizing column data types;
addressing incongruent data types;
normalizing column names;
normalizing table names;
replacing multiple primary keys with a single key;
grammatical fixes; or
replacing non-numeric primary keys.

6. The method of claim 4 wherein
the resolutions relate to relational, normalization, column normalization, table convention, column convention, or enterprise-class aspects of the code; or
the scripts are selected from a script library having been automatically generated for each of a corresponding two or more database technologies, or
presenting the scripts to a developer for determining selected scripts, and executing the selected scripts against the model in a recursive manner.

7. A method for generating code from a model of a database, comprising:
automated authoring of base application code from the model using artificial intelligence;
generating an extended application code structure for subsequent placement of extended application code, wherein components of the extended application code may include one or more code extensions, attributes, properties or rules that are specified other than by generating from the model;
storing the extended application code structure separately from the base application code;
exposing the base application code and extended application code structure for developer review;
accepting developer modifications, if any, to the base application code;
accepting developer modifications, if any, to the components of the extended application code structure;
accepting developer modifications to the model to provide a revised model; and
regenerating code by:
overwriting any developer modifications to the base application code by regenerating the base application code from the revised model; and
otherwise preventing any overwriting of the components of the extended application code structure after such developer modification are made to the components of the extended application code.

8. The method of claim 7 additionally comprising:
generating base Application Programming Interface (API) code from the model that comprises two or more different API methods;
generating an extended API code structure for subsequent placement of extended API code;
storing the extended API code structure separately from any base API code;
exposing the base API code and extended API code structure for developer review;
accepting developer modifications, if any, to the base API code;
accepting developer modifications, if any, to the extended API code structure, including extended API code;
regenerating the base API code from the revised model by:
overwriting any developer modifications to the base API code; and
otherwise preventing any overwriting of the API extended code after such developer modifications are made to the extended API code.

9. The method of claim 7 wherein the base application code implements an enterprise class application.

10. The method of claim 7 comprising:
generating base user interface (UI) code from the model;
generating an extended UI code structure for subsequent placement of extended UI code;
storing the extended UI code structure separately from any base UI code;
exposing the base UI code and extended UI code structure for developer review;
accepting developer modifications, if any, to the base UI code;
accepting developer modifications, if any, to the extended UI code structure, including extended UI code;
regenerating the base UI code from the revised model by:
overwriting any developer modifications to the base UI code; and
otherwise preventing any overwriting of the UI extended code after such developer modifications are made to the extended UI code;
and optionally further:
generating a compiled representation from one or more of (a) the base application code, (b) extended application code, or (c) base UI code; and
late binding of the extended UI code stored in the configuration file, by interpreting the configuration file when the compiled representation is executed.

11. A method for generating code from a model of a database, comprising:
automated authoring of base application code from the model using artificial intelligence;
generating an extended application code structure for subsequent placement of extended application code, wherein components of the extended application code may in include one or more code extensions, attributes, properties or rules that are specified other than by generating from the model;
storing the extended application code structure separately from the base application code;
exposing the base application code and extended application code structure for developer review;
accepting developer modifications, if any, to the base application code; and
wherein the base application code structure further comprises patterns that define further aspects of the automatically authored base application code.

12. The method of claim 11 wherein the patterns comprise:
a context pattern that defines handler classes for one or more contextual elements for the generated code.

13. The method of claim 11 wherein the contextual elements are selected from Localization, Messaging, Logging, Exception management, Auditing, Validation, Cryptography, Communications, or Cache management.

14. The method of claim 11 wherein the patterns additionally comprise:
action-response patterns that define responses generated as a result of actions taken, and optionally where
the action-response patterns define serialization of responses among code tiers or between code tiers.

15. The method of claim 11 wherein either
(a) the code tiers comprise an enterprise class application consisting of common base code, application logic code, API code and UI code; or
(b) the base application code and extended application code of an enterprise class application are provided for at least two different languages, databases, interfaces, or operating systems.

16. The method of claim 1 wherein the step of generating code from the model further comprises:
automated authoring of the code using artificial intelligence by further analyzing the data model.

17. The method of claim 7 wherein the step of generating base application code from the model further comprises:
automated authoring of the base application code using artificial intelligence by further analyzing the data model.
